(19) United States
(12) Patent Application Publication
(10) Pub. No.: US 2023/0345940 A1
(43) Pub. Date: Nov. 2, 2023

(54) INSECTICIDE

(71) Applicants: Western Sydney University, Werrington (AU); Cotton Research and Development Corporation, Narrabri (AU)

(72) Inventors: Robert Spooner-Hart, Penrith (AU); Karren Deanne Beattie, Penrith (AU); Albert Habib Basta, Penrith (AU); Michelle Yvette Mak, Penrith (AU); Zhonghua Chen, Penrith (AU)

(73) Assignees: Western Sydney University, Werrington (AU); Cotton Research and Development Corporation, Narrabri (AU)

(21) Appl. No.: 18/020,681

(22) PCT Filed: Aug. 17, 2021
(86) PCT No.: PCT/AU2021/050903

§ 371 Date: Feb. 10, 2023

(30) Foreign Application Priority Data
Aug. 18, 2020 (AU) 2020902941

(51) Int. Cl. A01N 43/16; A01P 7/04

(52) U.S. Cl. CPC A01N 43/16; A01P 7/04

(57) ABSTRACT

The present invention provides a γ-pyrone compound for use as an insecticide. The γ-pyrone is of the general Formula (1):

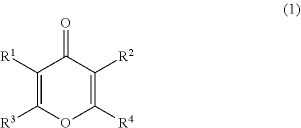

wherein: R¹, R², R³ and R⁴ are each independently selected from an optionally substituted C₁-C₁₂ alkyl, preferably C₁-C₆ alkyl, more preferably C₁-C₂ alkyl; H; —COOH; —OH; —OCH₃ or —R⁵(CH2)ₙR⁶R⁷CH₃; R⁵, R⁶, and R⁷ are each independently selected from an optionally substituted C₁-C₁₂ alkyl, preferably C₁-C₆ alkyl, more preferably C₁-C₂ alkyl; —C═O; —COO—, N, S or O; and n is 1 to 18, a salt, solvate, dimer or isomer thereof.

Other embodiments of the invention define use of the γ-pyrone compounds, insecticidal composition comprising the compound thereof and commercial embodiments include kits for on-the-shelf sale.

### RELATED APPLICATION

This application claims priority from Australian Provisional Patent Application No. 2020902941 filed 18 Aug. 2020, the contents of which should be understood to be incorporated.

### FIELD OF THE INVENTION

The present invention relates to pyrone derivative compounds which can be naturally (such as a plant extract) or synthetically derived for use as an insecticide.

### BACKGROUND OF THE INVENTION

Any discussion of the prior art throughout the specification should in no way be considered as an admission that such prior art is widely known or forms part of common general knowledge in the field.

Insect pests have been a problem for crops and stored food products since the dawn of agriculture. Since the 1950s, synthetic insecticides have been the method of choice for controlling insect pest infestations in the agricultural industry such as in crop fields, stored grain, warehouses and food processing facilities.

The Australian cotton industry also relies on repeated applications of synthetic pesticides to manage pests in crops. Accompanying problems associated with insecticide resistance, disruption of beneficial species, high cost of production, and environmental impact now require that alternative strategies be investigated for managing insect pests. These include (but are not limited to) genetically engineered cotton crops containing insecticidal proteins of Bacillus thuringiensis (“Bt”) and other host plant resistances, biopesticides, better management of beneficial species, trap crops, intercropping and companion planting, and manipulation of the behaviour of pests and beneficial insects. Genetically-engineered (transgenic) crops are now grown in Australia and many countries to control lepidopteran pests and their introduction has reduced synthetic insecticide use against these pests.

Despite plant-derived insecticides being well-known and indeed applied already to the cotton industry, there remains an ongoing desire to find new insecticidal compounds. Moreover, the Australian cotton industry is beset by a unique set of environmental, climatic, and pest species—for instance, aphids.

About 5000 species of aphid have been described and of these, some 450 species have colonised food and fibre crops. Aphids can cause serious economic damage in the agricultural industry. Aphids can damage crops including cotton and reduce yields, but they have a greater impact by being vectors of plant viruses. The transmission of these viruses depends on the movements of aphids between different parts of a plant, between nearby plants and further afield. In this respect, the probing behaviour of an aphid tasting a host is more damaging than lengthy aphid feeding and reproduction by stay-put individuals.

Insecticidal control of aphids is difficult, as they breed rapidly, so even small areas missed may enable a population to recover promptly. Aphids may occupy the undersides of leaves where spray misses them, while systemic insecticides do not move satisfactorily into flower petals. Finally, some aphid species are resistant to common insecticide classes including carbamates, organophosphates, and pyrethroids.

It is an object of the present invention to overcome or ameliorate one or more of the disadvantages of the prior art, or at least to provide a useful alternative.

It is an object of at least one preferred form of the present invention to provide a compound, insecticidal composition or extract that may control insect pests in a crop or ornamental plant.

Although the invention will be described with reference to specific examples it will be appreciated by those skilled in the art that the invention may be embodied in many other forms.

### SUMMARY OF THE INVENTION

According to a first aspect of the present invention there is provided a γ-pyrone compound for use as an insecticide. In preferred embodiments, the γ-pyrone compound is a podopyrone.

In certain embodiments, the γ-pyrone is of the general Formula (1):

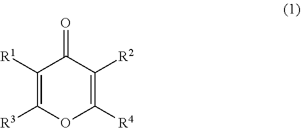

wherein:

R¹, R², R³ and R⁴ are each independently selected from an optionally substituted C₁-C₁₂ alkyl, preferably C₁-C₆ alkyl, more preferably C₁-C₂ alkyl; H; —COOH; —OH; —OCH₃ or —R⁵(CH2)ₙR⁶R⁷CH_{3;}

R⁵, R⁶, and R⁷ are each independently selected from an optionally substituted C₁-C₁₂ alkyl, preferably C₁-C₆ alkyl, more preferably C₁-C₂ alkyl; —C═O; —COO—, N, S or O; and

n is 1 to 18,

a salt, solvate, dimer or isomer thereof.

In certain embodiments, the γ-pyrone is of the general Formula (2):

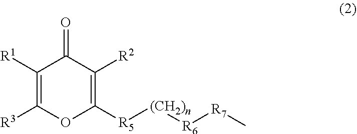

wherein:

R¹, R², R³ are each independently selected from C₁-C₁₂ alkyl, preferably C₁-C₆ alkyl, more preferably C₁-C₂ alkyl, wherein said C₁-C₁₂ alkyl, C₁-C₆ alkyl and C₁-C₂ alkyl may be optionally substituted with an epoxide, glycoside, acetoxy, halogen, cyano, amino, phenyl, heteroaryl; H; —COOH; —OH; or —OCH_{3,}

R⁵, R⁶, and R⁷ are each independently selected from C₁-C₁₂ alkyl, preferably C₁-C₆ alkyl, more preferably C₁-C₂ alkyl, wherein said C₁-C₁₂ alkyl, C₁-C₆ alkyl and C₁-C₂ alkyl may be optionally substituted with an C₁-C₁₂ alkyl, preferably C₁-C₆ alkyl, more preferably C₁-C₂ alkyl, epoxide, glycoside, acetoxy, halogen, cyano, amino, alcohol, phenyl, heteroaryl; —C═O; —COO—, N, S or O; and

n is 1 to 18,

a salt, solvate, dimer or isomer thereof.

In certain embodiments, the γ-pyrone is of the general Formula (3):

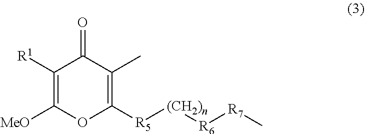

wherein:

n is 6, 7 or 8;

R¹ is C₁-C₁₂ alkyl, preferably C₁-C₆ alkyl, more preferably C₁-C₂ alkyl; and

R⁵, R⁶ and R⁷ are each independently selected from —C═O and —CH_{2—,}

with the proviso that if one of R⁵, R⁶ and R⁷ is —C═O then the remaining groups are —CH_{2—.}

In certain embodiments, the γ-pyrone is a compound selected from the group consisting of compounds (1a) to (1q), a salt, solvate, dimer or isomer thereof as described herein.

According to a second aspect of the present invention there is provided an insecticidal composition comprising a γ-pyrone compound as described herein.

Surprisingly, the present inventors have found that the γ-pyrone compound or insecticidal compositions comprising the compound thereof have selectivity against specific insecticidal pests and can have minimal impact on non-target organisms such as beneficials.

In preferred embodiments, the present inventors have surprisingly found that the γ-pyrone compound or insecticidal compositions comprising the compound thereof have high mortality against aphids and mites, without significant impact against Apis. The present inventors have shown that the γ-pyrone compound has minimal impact against Apis mellifera, which is regarded as one of the most important pollinators of agricultural crops worldwide because of its abundance and amenity to human handling.

According to a third aspect of the present invention there is provided a formulation for controlling insect pests, said formulation comprising:

one or more agronomically-acceptable diluents and/or carriers and/or other additives such as emulsifiers, wetting agents, surfactants, stabilisers, spreaders or the like; and

an insecticidally-effective amount of a compound or insecticidal composition comprising of one or more γ-pyrone compound/s as described herein,

wherein the formulation, in use, elicits insecticidal activity and/or repels the insect pest and/or deters the insect pest from laying eggs and/or influences the position of egg laying and/or deters the insect pest from feeding on a plant.

According to a fourth aspect of the present invention there is provided use of an insecticidally-effective amount of a compound or insecticidal composition comprising of one or more γ-pyrone compound/s as described herein for controlling insect pests by eliciting insecticidal activity and/or repelling the insect pest and/or deterring the insect pest from laying eggs and/or influencing the position of egg laying and/or deterring the insect pest from feeding on a plant.

According to a fifth aspect of the present invention there is provided a method of controlling one or more insect pests, the method comprising treating a locus with an insecticidally-effective amount of a compound or insecticidal composition comprising of one or more γ-pyrone compound/s as described herein, by eliciting insecticidal activity and/or repelling the insect pest and/or deterring the insect pest from laying eggs and/or influencing the position of egg laying and/or deterring the insect pest from feeding on a plant.

The present inventors have surprisingly found that the γ-pyrone compound or insecticidal compositions comprising the compound thereof can affect at least two ion channels (such as neuronal ion channels) of the insect pest. In certain embodiments, the γ-pyrone compound or insecticidal compositions comprising the compound thereof can affect at least two ion channels selected from the group consisting of sodium, potassium and chloride ion channels.

In preferred embodiments, the γ-pyrone compound or insecticidal compositions comprising the compound thereof can cause an efflux (outflow) of sodium and potassium ions from the target cells of insect pests. In preferred embodiments, the γ-pyrone compound or insecticidal compositions comprising the compound thereof can cause an influx (inflow) of chloride ions from the target cells of insect pests.

Typically, insecticidal compounds only affect a single ion channel. Surprisingly, the γ-pyrone compound or insecticidal compositions of the present invention can have dual modes of action, that is, can affect at least two ion channels of insect pests which can elicit nerve poisoning-type modes of action.

According to a sixth aspect of the present invention there is provided a kit for on-the-shelf sale, the kit comprising:

a compound or insecticidal composition comprising of one or more γ-pyrone compound/s as described herein;

one or more agronomically-acceptable diluents and/or carriers and/or other additives such as emulsifiers, wetting agents, surfactants, stabilisers, spreaders or the like;

instructions for preparing a formulation comprising an insecticidally-effective amount of the compound or insecticidal composition comprising of one or more γ-pyrone compound/s as described herein per unit volume of the one or more agronomically-acceptable diluents and/or carriers and/or other additives such as emulsifiers, wetting agents, surfactants, stabilisers, spreaders or the like.

In an embodiment, the kit further comprises application means in the form of a sprayer or the like, optionally within which the formulation is prepared.

According to a seventh aspect of the present invention there is provided an insecticidal composition for controlling insect pests, said insecticidal composition comprising one or more extracts from the genera Podolepis, Gonystylus and combinations thereof comprising one or more secondary plant compounds (SPCs) having insecticidal activity and/or which repel the insect pest and/or deter the insect pest from laying eggs and/or influence the position of egg laying and/or deter the insect pest from feeding on a plant.

According to an eighth aspect of the present invention there is provided a formulation for controlling insect pests, said formulation comprising:

one or more agronomically-acceptable diluents and/or carriers and/or other additives such as emulsifiers, wetting agents, surfactants, stabilisers, spreaders or the like; and

an insecticidally-effective amount of an insecticidal composition comprising one or more extracts from the genera Podolepis, Gonystylus and combinations thereof comprising one or more secondary plant compounds (SPCs) as described herein,

wherein the formulation, in use, elicits insecticidal activity and/or repels the insect pest and/or deters the insect pest from laying eggs and/or influences the position of egg laying and/or deters the insect pest from feeding on a plant.

According to a ninth aspect of the present invention there is provided use of an insecticidally-effective amount of an insecticidal composition comprising of one or more extracts from the genera Podolepis, Gonystylus and combinations thereof comprising one or more secondary plant compounds (SPCs) as described herein for controlling insect pests by eliciting insecticidal activity and/or repelling the insect pest and/or deterring the insect pest from laying eggs and/or influencing the position of egg laying and/or deterring the insect pest from feeding on a plant.

According to a tenth aspect of the present invention there is provided a method of controlling one or more insect pests, the method comprising treating a locus with an insecticidally-effective amount of an insecticidal composition comprising one or more extracts from the genera Podolepis, Gonystylus and combinations thereof comprising one or more secondary plant compounds (SPCs) as described herein, by eliciting insecticidal activity and/or repelling the insect pest and/or deterring the insect pest from laying eggs and/or influencing the position of egg laying and/or deterring the insect pest from feeding on a plant.

As discussed herein, the present inventors have surprisingly found that a composition comprising one or more extracts from the genera Podolepis, Gonystylus and combinations thereof comprising one or more secondary plant compounds (SPCs) as described herein can affect at least two ion channels (such as neuronal ion channels) of the insect pest. In certain embodiments, the SPCs can affect at least two ion channels selected from the group consisting of sodium, potassium and chloride ion channels.

In preferred embodiments, the SPCs can cause an efflux (outflow) of sodium and potassium ions from the target cells of insect pests. In preferred embodiments, the SPCs can cause an influx (inflow) of chloride ions from the target cells of insect pests.

According to an eleventh aspect of the present invention there is provided a kit for on-the-shelf sale, the kit comprising:

an insecticidal composition comprising one or more extracts from the genera Podolepis, Gonystylus and combinations thereof comprising one or more secondary plant compounds (SPCs) as described herein;

one or more agronomically-acceptable diluents and/or carriers and/or other additives such as emulsifiers, wetting agents, surfactants, stabilisers, spreaders or the like;

instructions for preparing a formulation comprising an insecticidally-effective amount of the one or more SPC/s per unit volume of the one or more agronomically-acceptable diluents and/or carriers and/or other additives such as emulsifiers, wetting agents, surfactants, stabilisers, spreaders or the like.

In an embodiment, the kit further comprises application means in the form of a sprayer of the like, optionally within which the formulation is prepared.

The present inventors have surprisingly found that an extract comprising an SPC (in an embodiment, a γ-pyrone) has significant insecticidal activity against insect pests, particularly against aphids and mites.

In particular, the present inventors have found that an extract derived from Podolepis jaceoides comprising a podopyrone has significant insecticidal activity against insect pests, particularly against aphids and mites.

In some embodiments, the SPC is an γ-pyrone. In some embodiments, the γ-pyrone is a podopyrone. In certain embodiments, the podopyrone is selected from the group consisting of 10′-oxopodopyrone, 10′-oxo-8-methylpodopyrone, 9′-oxopodopyrone, 9′-oxo-8-methylpodopyrone, 1′-oxo-nor-podopyrone, 1′-oxopodopyrone, 1′-deoxo-8-methyl-1′-oxonorpodopyrone, 8-methylpodopyrone, 8-methyl-1′-oxo-nor-podopyrone, 1′-oxo-8-methylpodopyrone, podopyrone, norpodopyrone, homopodopyrone, 10′-hydroxy-8-methylpodopyrone, 10′-acetoxy-8-methylpodopyrone, 10′-acetoxypodopyrone and combinations thereof.

In certain embodiments, the extract comprising a γ-pyrone is derived from the genus Podolepis, Gonystylus and combinations thereof.

In certain embodiments, the Podolepis-derived extract is selected from the group consisting of Podolepis labill, Podolepis acuminata, Podolepis affinis Sond., Podolepis aristata, Podolepis arachnoidea, Podolepis auriculata, Podolepis basalt plain, Podolepis canescens, Podolepis capillaris, Podolepis carnarvon, Podolepis centauroides, Podolepis chrysantha, Podolepis contorta, Podolepis cupulata, Podolepis davisiana, Podolepis decipiens, Podolepis divaricata, Podolepis sect. Doratolepis, Podolepis eremaea, Podolepis ferruginea, Podolepis filiformis, Podolepis gardneri, Podolepis georgei, Podolepis gracilis, Podolepis gibertii, Podolepis gnaphalioides, Podolepis gracilis, Podolepis great victoria desert, Podolepis hieracioides, Podolepis inundata, Podolepis jaceoides, Podolepis kendallii, Podolepis laciniata, Podolepis laevigata, Podolepis lessonii, Podolepis linearifolia, Podolepis longipedata, Podolepis lucaeana, Podolepis macrocephala, Podolepis microcephala, Podolepis mitchellii, Podolepis monticola, Podolepis muelleri, Podolepis neglecta, Podolepis nutans, Podolepis omissa, Podolepis pallida, Podolepis papillosa, Podolepis remota, Podolepis rhytidochlamys, Podolepis robusta, Podolepis rosea, Podolepis rosmarinifolia, Podolepis rubida, Podolepis rugata, Podolepis rutidoclamys, Podolepis scalia, Podolepis siemssenia, Podolepis siemssenii, Podolepis simplicicaulis, Podolepis spenceri, Podolepis tepperi, Podolepis sp. aff. robusta, Podolepis N.E. Alps, Podolepis Warrabah, Podolepis Wollunga Well, Podolepis stylolepis, Podolepis subulata, Podolepis tepperi, Podolepis tetrachaeta and combinations thereof.

In certain embodiments, the Gonystylus-derived extract is selected from the group consisting of Gonystylus acuminatus, Gonystylus affinis, Gonystylus areolatus, Gonystylus augescens, Gonystylus bancanus, Gonystylus borneensis, Gonystylus brunnescens, Gonystylus calophylloides, Gonystylus calophyllus, Gonystylus confusus, Gonystylus consanguineus, Gonystylus costalis, Gonystylus decipiens, Gonystylus eximius, Gonystylus forbesii, Gonystylus glaucescens, Gonystylus keithii, Gonystylus lucidulus, Gonystylus macrocarpus, Gonystylus macrophyllus, Gonystylus maingayi, Gonystylus micranthus, Gonystylus nervosus, Gonystylus nobilis, Gonystylus othmanii, Gonystylus pendulus, Gonystylus punctatus, Gonystylus reticulatus, Gonystylus spectabilis, Gonystylus stenosepalus, Gonystylus velutinus, Gonystylus xylocarpus and combinations thereof.

In preferred embodiments, the extract comprising a γ-pyrone is derived from Podolepis jaceoides, Gonystylus keithii and combinations thereof.

As described above, the present invention provides a method of controlling one or more insect pests, the method comprising treating a locus with an insecticidally-effective amount of a compound or insecticidal composition of the present invention, or with an insecticidal composition comprising one or more extracts from the genera Podolepis, Gonystylus and combinations thereof comprising one or more secondary plant compounds (SPCs) as described herein by eliciting insecticidal activity and/or repelling the insect pest and/or deterring the insect pest from laying eggs and/or influencing the position of egg laying and/or deterring the insect pest from feeding on a plant.

The present inventors have surprisingly found use of low concentrations of an extract comprising a γ-pyrone has significant insecticidal activity against insect pests (for example less than 2 w/v % active ingredient, preferably less than 1 w/v % active ingredient).

In one embodiment, the method comprises treating a locus with the compound, insecticidal composition or an extract comprising a γ-pyrone of the present invention at a concentration of less than about 20 w/v %, less than about 15 w/v %, less than about 10 w/v %, less than about 5 w/v %, less than about 3 w/v %, less than about 2 w/v %, less than 20 about 1 w/v %, less than about 0.5 w/v % and less than about 0.25 w/v %.

In one embodiment, the method comprises treating a locus with the compound, insecticidal composition or an extract comprising a γ-pyrone of the present invention at a concentration of between about 0.25 and about 20 w/v %, between about 0.25 and about 15 w/v %, between about 0.25 and about 10 w/v %, between about 0.25 and about 5 w/v %, 25 between about 0.25 and about 3 w/v %, preferably between about 0.25 and about 2 w/v %, between about 0.25 and about 1 w/v %, between about 0.5 and about 1 w/v %.

In certain embodiments, the method comprises treating a locus with an SPC (i.e., active ingredient) at a concentration of less than about 20 w/v %, less than about 15 w/v %, less than about 10 w/v %, less than about 5 w/v %, less than about 3 w/v %, less than about 2 w/v %, less than about 1 w/v %, less than about 0.5 w/v % and less than about 0.25 w/v %.

In certain embodiments, the method comprises treating a locus with an SPC (i.e., active ingredient) at a concentration of between about 0.001 and about 20 w/v %, between about 0.001 and about 15 w/v %, between about 0.001 and about 10 w/v %, between about 0.001 and about 5 w/v %, between about 0.001 and 3 w/v %, between about 0.001 and 2 w/v %, between about 0.001 and 1 w/v %, between about 0.005 and 0.5 w/v % and between about 0.001 and 0.1 w/v %.

In certain embodiments, the method comprises treating a locus with an SPC (i.e., active ingredient) at a concentration of between about 1 and about 30000 ppm, between about 30 and about 30000 ppm, between about 50 and about 30000 ppm, between about 100 and about 30000 ppm, between about 150 and about 30000 ppm, between about 200 and about 30000 ppm, between about 300 and about 30000 ppm, between about 300 and about 25000 ppm, between about 300 and about 16000 ppm, between about 300 and about 15000 ppm, between about 300 and about 12000 ppm, between about 3000 and about 12000 ppm.

In an embodiment, the insect pest is a plant pest and the method comprises applying a compound, insecticidal composition or an extract comprising a γ-pyrone of the present invention to the plant or its surroundings.

Definitions

In describing and claiming the present invention, the following terminology will be used in accordance with the definitions set out below. It is also to be understood that the terminology used herein is for the purpose of describing particular embodiments of the invention only and is not intended to be limiting. Unless defined otherwise, all technical and scientific terms used herein have the same meaning as commonly understood by one having ordinary skill in the art to which the invention pertains.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic/s of the claimed subject matter.

With respect to the terms “comprising”, “consisting of”, and “consisting essentially of”, where one of these three terms is used herein, the presently disclosed and claimed subject matter may include the use of either of the other two terms. Thus, in some embodiments not otherwise explicitly recited, any instance of “comprising” may be replaced by “consisting of” or, alternatively, by “consisting essentially of”.

Other than in the operating examples, or where otherwise indicated, all numbers expressing quantities of ingredients or reaction conditions used herein are to be understood as modified in all instances by the term “about”, having regard to normal tolerances in the art. The examples are not intended to limit the scope of the invention. In what follows, or where otherwise indicated, “%” will mean “weight %”, “ratio” will mean “weight ratio” and “parts” will mean “weight parts”.

The term “substantially” as used herein shall mean comprising more than 50% by weight, where relevant, unless otherwise indicated.

The recitation of a numerical range using endpoints includes all numbers subsumed within that range (e.g., 1 to 5 includes 1, 1.5, 2, 2.75, 3, 3.80, 4, 5, etc.).

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

It must also be noted that, as used in the specification and the appended claims, the singular forms “a”, “an” and “the” include plural referents unless the context clearly dictates otherwise.

Although exemplary embodiments of the disclosed technology are explained in detail herein, it is to be understood that other embodiments are contemplated. Accordingly, it is not intended that the disclosed technology be limited in its scope to the details of construction and arrangement of components set forth in the following description or illustrated in the drawings. The disclosed technology is capable of other embodiments and of being practiced or carried out in various ways.

The term “optionally substituted” as used throughout the specification denotes that the group may or may not be further substituted or fused (so as to form a condensed polycyclic system), with one or more non-hydrogen substituent groups. In certain embodiments the substituent groups are one or more groups independently selected from the group consisting of halogen, ═O, ═S, —CN, —NO₂, —CF₃, —OCF₃, alkyl, alkenyl, alkynyl, haloalkyl, haloalkenyl, haloalkynyl, heteroalkyl, cycloalkyl, cycloalkenyl, heterocycloalkyl, heterocycloalkenyl, aryl, heteroaryl, cycloalkylalkyl, heterocycloalkylalkyl, heteroarylalkyl, arylalkyl, cycloalkylalkenyl, heterocycloalkylalkenyl, arylalkenyl, heteroarylalkenyl, cycloalkylheteroalkyl, heterocycloalkylheteroalkyl, arylheteroalkyl, heteroarylheteroalkyl, hydroxy, hydroxyalkyl, alkyloxy, alkyloxyalkyl, alkyloxycycloalkyl, alkyloxyheterocycloalkyl, alkyloxyaryl, alkyloxyheteroaryl, alkyloxycarbonyl, alkylaminocarbonyl, alkenyloxy, alkynyloxy, cycloalkyloxy, cycloalkenyloxy, heterocycloalkyloxy, heterocycloalkenyloxy, aryloxy, phenoxy, benzyloxy, heteroaryloxy, arylalkyloxy, amino, alkylamino, acylamino, aminoalkyl, arylamino, sulfonylamino, sulfinylamino, sulfonyl, alkyl sulfonyl, aryl sulfonyl, aminosulfonyl, sulfinyl, alkylsulfinyl, arylsulfinyl, aminosulfinylaminoalkyl, —C(═O)OH, —C(═O)R^{e}, —C(═O)OR^{e}, C(═O)NR^{e}R^{f}, C(═NOH)R^{e}, C(═NR^{e})NR^{f}R^{g}, NR^{e}R^{f}, NR^{e}C(═O)R^{f}, NR^{e}C(═O)OR^{f}, NR^{e}C(═O)NR^{f}R^{g}, NR^{e}C(═NR^{f})NR^{g}R^{h}, NR^{e}SO₂R^{f}, —SR^{e}, SO₂NR^{e}R^{f}, —OR^{e}, OC(═O)NR^{e}R^{f}, OC(═O)R^{e} and acyl,

wherein R^{e}, R^{f}, R^{g} and R^{h} are each independently selected from the group consisting of H, C₁-C₁₂alkyl, C₁-C₁₂haloalkyl, C₂-C₁₂alkenyl, C₂-C₁₂alkynyl, C₁-C₁₀heteroalkyl, C₃-C₁₂cycloalkyl, C₃-C₁₂cycloalkenyl, C₁-C₁₂heterocycloalkyl, C₁-C₁₂heterocycloalkenyl, C₆-C₁₈aryl, C₁-C₁₈heteroaryl, and acyl, or any two or more of R^{a}, R^{b}, R^{c} and R^{d}, when taken together with the atoms to which they are attached form a heterocyclic ring system with 3 to 12 ring atoms.

In some embodiments each optional substituent is independently selected from the group consisting of: halogen, ═O, ═S, —CN, —NO₂, —CF₃, —OCF₃, alkyl, alkenyl, alkynyl, haloalkyl, haloalkenyl, haloalkynyl, heteroalkyl, cycloalkyl, cycloalkenyl, heterocycloalkyl, heterocycloalkenyl, aryl, heteroaryl, hydroxy, hydroxyalkyl, alkyloxy, alkyloxyalkyl, alkyloxyaryl, alkyloxyheteroaryl, alkenyloxy, alkynyloxy, cycloalkyloxy, cycloalkenyloxy, heterocycloalkyloxy, heterocycloalkenyloxy, aryloxy, heteroaryloxy, arylalkyl, heteroarylalkyl, arylalkyloxy, amino, alkylamino, acylamino, aminoalkyl, arylamino, sulfonyl, alkyl sulfonyl, aryl sulfonyl, aminosulfonyl, aminoalkyl, —COOH, —SH, and acyl.

Examples of particularly suitable optional substituents include F, Cl, Br, I, CH₃, CH₂CH₃, OH, OCH₃, CF₃, OCF₃, NO₂, NH₂, and CN.

As used herein, the term “secondary plant compound” (SPC), is a chemical compound synthesised by a plant which is not essential to the survival of the plant. The SPCs of the present invention have insecticidal activity and/or repel the insect pest and/or deter the insect pest from laying eggs and/or influence the position of egg laying and/or deter the insect pest from feeding on the plant.

For purposes of simplicity, the term “insect” or its equivalents or derivatives such as “insecticidal” shall be used in this application; however, it should be understood that the term “insect” refers, not only to insects but to their immature forms and larvae.

As used herein, the term “insecticidal activity” refers to the killing of insect pests, that is, the mortality of the insect pests.

### BRIEF DESCRIPTION OF THE DRAWINGS

Certain preferred embodiments of the invention will now be described, by way of example only, with reference to the accompanying drawings in which:

FIG. 1 shows the net ion flux for K⁺⁻under control conditions (0-15 mins) and post-treatment of negative control (A) DMSO 1.0% w/v, and positive controls (B) Pyrethrum 0.01% w/v and (C) Tasmanone 0.01% w/v.

FIG. 2 shows the net ion flux for Na⁺under control conditions (0-15 mins) and post-treatment of negative control (A) DMSO 1.0% w/v, and positive controls (B) Pyrethrum 0.01% w/v and (C) Tasmanone 0.01% w/v.

FIG. 3 shows the net ion flux for Cl⁻under control conditions (0-15 mins) and post-treatment of negative control (A) DMSO 1.0% w/v, and positive controls (B) Pyrethrum 0.01% w/v and (C) Tasmanone 0.01% w/v.

FIG. 4 shows (A) the net ion flux traces under control conditions (0-15 mins) and post-treatment of negative control for K⁺; and (B) the relative response of each treatment to its own control, comparing 0.01% w/v extract of the present invention to DMSO 1.0% w/v, pyrethrum 0.01% w/v and tasmanone 0.01% w/v.

FIG. 5 shows (A) the net ion flux traces under control conditions (0-15 mins) and post-treatment of negative control for Cl⁻; and (B) the relative response of each treatment to its own control, comparing 0.01% w/v extract of the present invention to DMSO 1.0% w/v, pyrethrum 0.01% w/v and tasmanone 0.01% w/v.

FIG. 6 shows (A) the net ion flux traces under control conditions (0-15 mins) and post-treatment of negative control for Na⁺; and (B) the relative response of each treatment to its own control, comparing 0.01% w/v extract of the present invention to DMSO 1.0% w/v, pyrethrum 0.01% w/v and tasmanone 0.01% w/v.

FIG. 7 is a Markush structure corresponding to selected γ-pyrones of the present invention. In particular, R¹, R², R³ and R⁴ are each independently selected from an optionally substituted C₁-C₁₂ alkyl, preferably C₁-C₆ alkyl, more preferably C₁-C₂ alkyl; H; —COOH; —OH; —OCH₃ or —R⁵(CH2)ₙR⁶R⁷CH₃; R⁵, R⁶, and R⁷ are each independently selected from an optionally substituted C₁-C₁₂ alkyl, preferably C₁-C₆ alkyl, more preferably C₁-C₂ alkyl; —C═O; —COO—, N, S or O; and n is 1 to 18, a salt, solvate, dimer or isomer thereof.

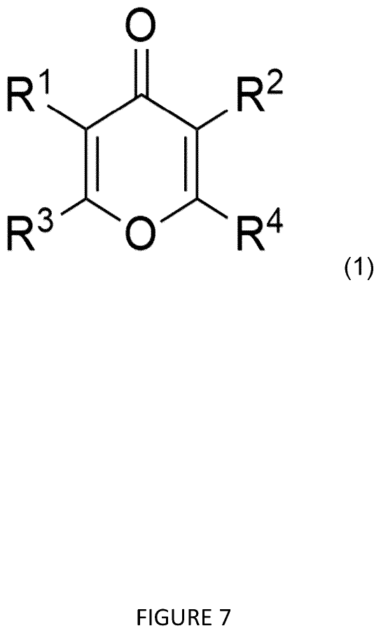

### DETAILED DESCRIPTION OF THE INVENTION

The skilled addressee will understand that the invention comprises the embodiments and features disclosed herein as well as all combinations and/or permutations of the disclosed embodiments and features.

The present inventors have developed an insecticide based on a γ-pyrone compound derivate having insecticidal efficacy against pests.

Compound and Composition

As described above, the present invention provides a γ-pyrone compound for use as an insecticide. In some embodiments, the γ-pyrone is a podopyrone.

As is known to a person skilled in the art, a pyrone is a heterocyclic compound containing an unsaturated six-membered ring containing one oxygen atom and a ketone functional group. A γ-pyrone (also known as a 4-pyrone) can be functionalised on the C2, C3, C5 and C6 carbons.

In some embodiments, the γ-pyrone compound is of the general Formula (1):

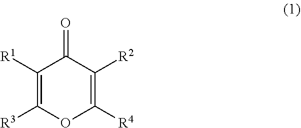

wherein:

R¹, R², R³ and R⁴ are each independently selected from an optionally substituted C₁-C₁₂ alkyl, preferably C₁-C₆ alkyl, more preferably C₁-C₂ alkyl; H; —COOH; —OH; —OCH₃ or —R⁵(CH2)ₙR⁶R⁷CH_{3;}

R⁵, R⁶, and R⁷ are each independently selected from an optionally substituted C₁-C₁₂ alkyl, preferably C₁-C₆ alkyl, more preferably C₁-C₂ alkyl; —C═O; —COO—, N, S or O; and

n is 1 to 18,

a salt, solvate, dimer or isomer thereof.

In some embodiments, the γ-pyrone compound is of the general Formula (1):

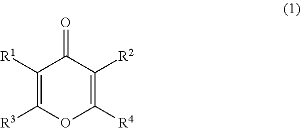

wherein:

R¹, R², R³ and R⁴ are each independently selected from C₁-C₁₂ alkyl, preferably C₁-C₆ alkyl, more preferably C₁-C₂ alkyl, wherein said C₁-C₁₂ alkyl, C₁-C₆ alkyl and C₁-C₂ alkyl may be optionally substituted with an epoxide, glycoside, acetoxy, halogen, cyano, amino, alcohol, phenyl, heteroaryl; H; —COOH; —OH; —OCH₃ or —R⁵(CH2)ₙR⁶R⁷CH_{3;}

R⁵, R⁶, and R⁷ are each independently selected from C₁-C₁₂ alkyl, preferably C₁-C₆ alkyl, more preferably C₁-C₂ alkyl, wherein said C₁-C₁₂ alkyl, C₁-C₆ alkyl and C₁-C₂ alkyl may be optionally substituted with an C₁-C₁₂ alkyl, preferably C₁-C₆ alkyl, more preferably C₁-C₂ alkyl, epoxide, glycoside, acetoxy, halogen, cyano, amino, alcohol, phenyl, heteroaryl; —C═O; —COO—, N, S or O; and

n is 1 to 18,

a salt, solvate, dimer or isomer thereof.

In certain embodiments, the γ-pyrone is of the general Formula (1):

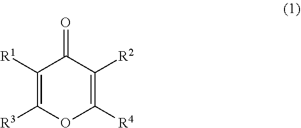

wherein:

R¹, R², R³ and R⁴ are each independently selected from C₁-C₁₂ alkyl, preferably C₁-C₆ alkyl, more preferably C₁-C₂ alkyl; H; —COOH; —OH; —OCH₃; or —R⁵(CH2)ₙR⁶R⁷CH_{3;}

R⁵, R⁶, and R⁷ are each independently selected from C₁-C₁₂ alkyl, preferably C₁-C₆ alkyl, more preferably C₁-C₂ alkyl, wherein said C₁-C₁₂ alkyl, C₁-C₆ alkyl and C₁-C₂ alkyl may be optionally substituted with an C₁-C₁₂ alkyl, preferably C₁-C₆ alkyl, more preferably C₁-C₂ alkyl, epoxide, glycoside, acetoxy, halogen, cyano, amino, alcohol, phenyl, heteroaryl; —C═O; —COO—, N, S or O; and

n is 1 to 18,

a salt, solvate, dimer or isomer thereof.

In some embodiments, the γ-pyrone is of the general Formula (1):

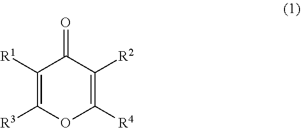

wherein:

R¹, R², R³ and R⁴ are each independently selected from C₁-C₁₂ alkyl, preferably C₁-C₆ alkyl, more preferably C₁-C₂ alkyl; H; —COOH; —OH; —OCH₃; or —R⁵(CH2)ₙR⁶R⁷CH_{3;}

R⁵, R⁶, and R⁷ are each independently selected from C₁-C₁₂ alkyl, preferably C₁-C₆ alkyl, more preferably C₁-C₂ alkyl, wherein said C₁-C₂ alkyl, ₁-C₆ alkyl and C₁-C₂ alkyl may be optionally substituted with an C₁-C₁₂ alkyl, preferably C₁-C₆ alkyl, more preferably C₁-C₂ alkyl, epoxide, glycoside, acetoxy, halogen, cyano, amino, alcohol, phenyl, heteroaryl; —C═O; —COO—, N, S or O; and

n is 1 to 18,

with the proviso that at least one of R¹, R², R³ and R⁴ is R⁵(CH2)ₙR⁶R⁷CH_{3,}

a salt, solvate, dimer or isomer thereof.

In certain embodiments, the γ-pyrone is of the general Formula (2):

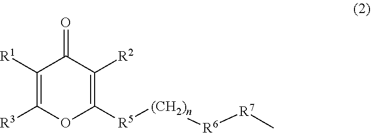

wherein:

R¹, R², R³ are each independently selected from C₁-C₁₂ alkyl, preferably C₁-C₆ alkyl, more preferably C₁-C₂ alkyl, wherein said C₁-C₁₂ alkyl, C₁-C₆ alkyl and C₁-C₂ alkyl may be optionally substituted with an epoxide, glycoside, acetoxy, halogen, cyano, amino, phenyl, heteroaryl; H; —COOH; —OH; or —OCH_{3,}

R⁵, R⁶, and R⁷ are each independently selected from C₁-C₁₂ alkyl, preferably C₁-C₆ alkyl, more preferably C₁-C₂ alkyl, wherein said C₁-C₁₂ alkyl, C₁-C₆ alkyl and C₁-C₂ alkyl may be optionally substituted with an C₁-C₁₂ alkyl, preferably C₁-C₆ alkyl, more preferably C₁-C₂ alkyl, epoxide, glycoside, acetoxy, halogen, cyano, amino, alcohol, phenyl, heteroaryl; —C═O; —COO—, N, S or O; and

n is 1 to 18,

a salt, solvate, dimer or isomer thereof.

In certain embodiments, the γ-pyrone compound is of the general Formula (2):

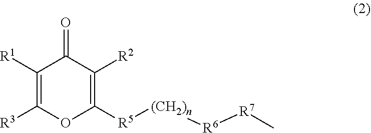

wherein:

R¹, R², R³ are each independently selected from C₁-C₁₂ alkyl, preferably C₁-C₆ alkyl, more preferably C₁-C₂ alkyl; H; —COOH; —OH; or —OCH_{3;}

R⁵, R⁶, and R⁷ are each independently selected from C₁-C₁₂ alkyl, preferably C₁-C₆ alkyl, more preferably C₁-C₂ alkyl, wherein said C₁-C₁₂ alkyl, C₁-C₆ alkyl and C₁-C₂ alkyl may be optionally substituted with an C₁-C₁₂ alkyl, preferably C₁-C₆ alkyl, more preferably C₁-C₂ alkyl, epoxide, glycoside, acetoxy, halogen, cyano, amino, alcohol, phenyl, heteroaryl; —C═O; —COO—, N, S or O; and

n is 1 to 18,

a salt, solvate, dimer or isomer thereof.

In certain embodiments, the γ-pyrone compound is of the general Formula (2):

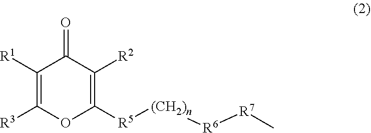

wherein:

R¹, R², R³ are each C₁-C₂ alkyl; H; —COOH; —OH; or —OCH_{3;}

R⁵, R⁶, and R⁷ are each independently selected from C₁-C₁₂ alkyl, preferably C₁-C₆ alkyl, more preferably C₁-C₂ alkyl; —C═O, —COO—, N, S or O; and

n is 1 to 18,

a salt, solvate, dimer or isomer thereof.

In some embodiments, the γ-pyrone is of the general Formula (3):

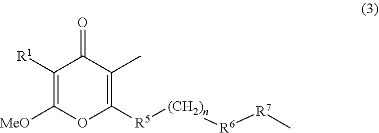

wherein:

n is 6, 7 or 8;

R¹ is C₁-C₁₂ alkyl, preferably C₁-C₆ alkyl, more preferably C₁-C₂ alkyl; and

R⁵, R⁶ and R⁷ are each independently selected from —C═O and —CH₂—,

with the proviso that if one of R⁵, R⁶ and R⁷ is —C═O then the remaining groups are —CH₂—.

In preferred embodiments, the γ-pyrone is selected from the group consisting of compounds (1a) to (1q):

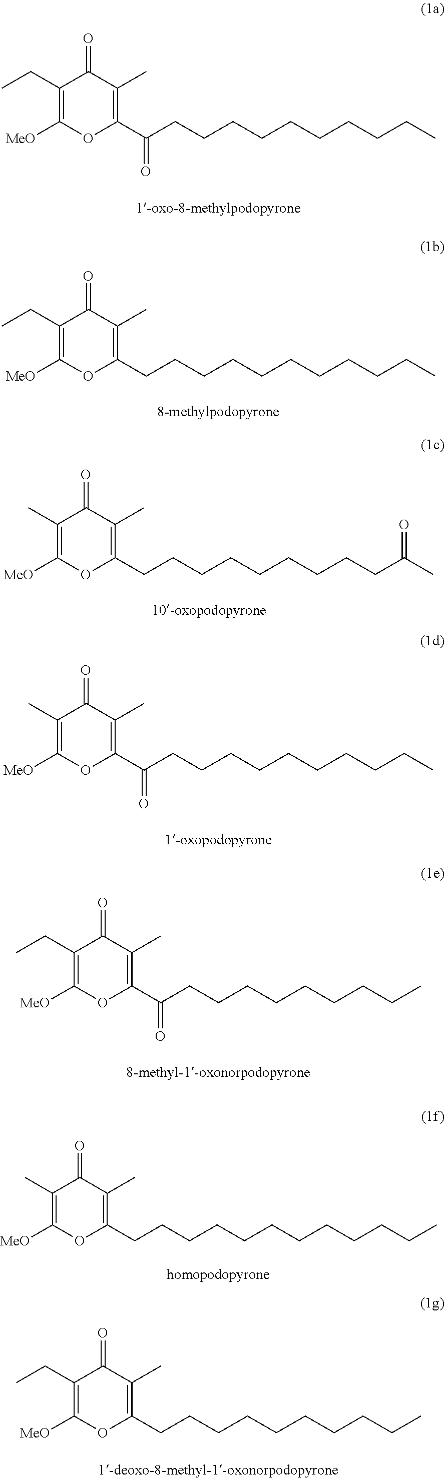

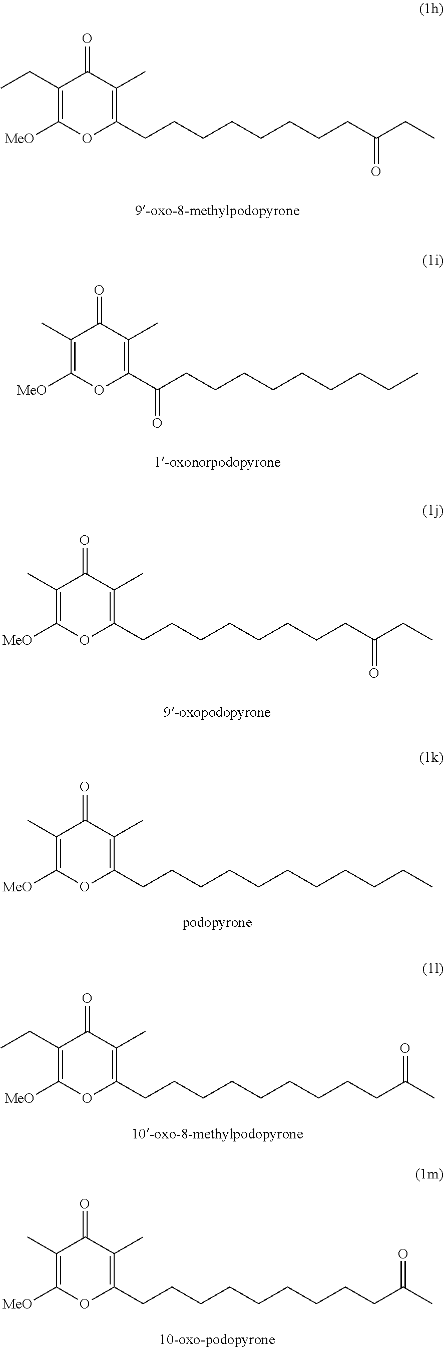

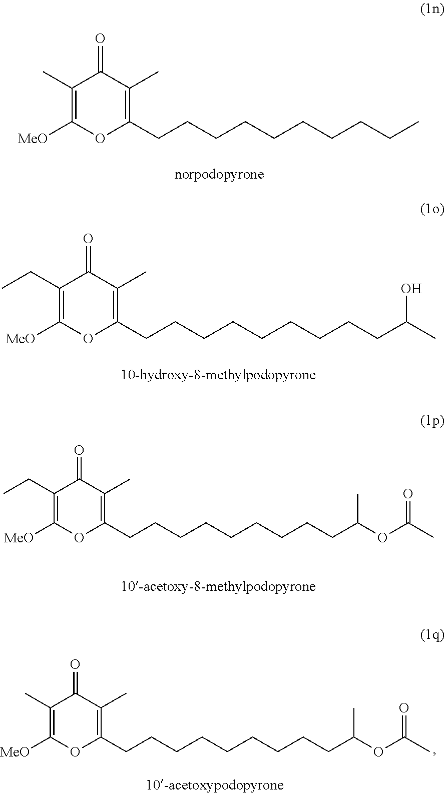

a salt, solvate, dimer or isomer thereof.

In preferred embodiments, the γ-pyrone compound of the general Formula (1) is 10′-oxopodopyrone (1c).

In preferred embodiments, the γ-pyrone compound of the general Formula (1) is 10′-oxo-8-methyl podopyrone (11).

In another aspect, the present invention provides an insecticidal composition comprising a γ-pyrone compound as described herein.

In certain embodiments, the podopyrone is selected from the group consisting of 10′-oxopodopyrone, 10′-oxo-8-methylpodopyrone, 9′-oxopodopyrone, 9′-oxo-8-methylpodopyrone, 1′-oxo-nor-podopyrone, 1′-oxopodopyrone, 1′-deoxo-8-methyl-1′-oxonorpodopyrone, 8-methylpodopyrone, 8-methyl-1′-oxo-nor-podopyrone, 1′-oxo-8-methylpodopyrone, podopyrone, norpodopyrone, homopodopyrone, 10′-hydroxy-8-methylpodopyrone, 10′-acetoxy-8-methylpodopyrone, 10′-acetoxypodopyrone and combinations thereof.

In certain embodiments, an extract is provided comprising a γ-pyrone derived from the genus Podolepis, Gonystylus and combinations thereof.

In certain embodiments, the Podolepis-derived extract is selected from the group consisting of Podolepis labill, Podolepis acuminata, Podolepis affinis Sond., Podolepis aristata, Podolepis arachnoidea, Podolepis auriculata, Podolepis basalt plain, Podolepis canescens, Podolepis capillaris, Podolepis carnarvon, Podolepis centauroides, Podolepis chrysantha, Podolepis contorta, Podolepis cupulata, Podolepis davisiana, Podolepis decipiens, Podolepis divaricata, Podolepis sect. Doratolepis, Podolepis eremaea, Podolepis ferruginea, Podolepis filiformis, Podolepis gardneri, Podolepis georgei, Podolepis gracilis, Podolepis gibertii, Podolepis gnaphalioides, Podolepis gracilis, Podolepis great victoria desert, Podolepis hieracioides, Podolepis inundata, Podolepis jaceoides, Podolepis kendallii, Podolepis laciniata, Podolepis laevigata, Podolepis lessonii, Podolepis linearifolia, Podolepis longipedata, Podolepis lucaeana, Podolepis macrocephala, Podolepis microcephala, Podolepis mitchellii, Podolepis monticola, Podolepis muelleri, Podolepis neglecta, Podolepis nutans, Podolepis omissa, Podolepis pallida, Podolepis papillosa, Podolepis remota, Podolepis rhytidochlamys, Podolepis robusta, Podolepis rosea, Podolepis rosmarinifolia, Podolepis rubida, Podolepis rugata, Podolepis rutidoclamys, Podolepis scalia, Podolepis siemssenia, Podolepis siemssenii, Podolepis simplicicaulis, Podolepis spenceri, Podolepis tepperi, Podolepis sp. aff. robusta, Podolepis N.E. Alps, Podolepis Warrabah, Podolepis Wollunga Well, Podolepis stylolepis, Podolepis subulata, Podolepis tepperi, Podolepis tetrachaeta and combinations thereof.

In certain embodiments, the Gonystylus-derived extract is selected from the group consisting of Gonystylus acuminatus, Gonystylus affinis, Gonystylus areolatus, Gonystylus augescens, Gonystylus bancanus, Gonystylus borneensis, Gonystylus brunnescens, Gonystylus calophylloides, Gonystylus calophyllus, Gonystylus confusus, Gonystylus consanguineus, Gonystylus costalis, Gonystylus decipiens, Gonystylus eximius, Gonystylus forbesii, Gonystylus glaucescens, Gonystylus keithii, Gonystylus lucidulus, Gonystylus macrocarpus, Gonystylus macrophyllus, Gonystylus maingayi, Gonystylus micranthus, Gonystylus nervosus, Gonystylus nobilis, Gonystylus othmanii, Gonystylus pendulus, Gonystylus punctatus, Gonystylus reticulatus, Gonystylus spectabilis, Gonystylus stenosepalus, Gonystylus velutinus, Gonystylus xylocarpus and combinations thereof.

In preferred embodiments, the extract comprising an γ-pyrone is derived from Podolepis jaceoides, Gonystylus keithii and combinations thereof.

Embodiments of the invention can be used to treat crops in order to limit or prevent insect infestation. The present invention is especially suitable for agronomically-important plants, which refers to a plant that is harvested or cultivated on a commercial scale.

One example of an agronomically-important crop is cotton. Further examples of such agronomic plants (or crops) are cereals, such as wheat, barley, rye, oats, rice, maize or sorghum; beet, such as sugar or fodder beet; fruit, for example pome fruit, stone fruit and soft fruit, such as apples, pears, plums, prunes, peaches, almonds, cherries or berries, for example strawberries, raspberries or blackberries; legumes, such as beans, lentils, peas or soya beans; oil crops such as oil seed rape, mustard, poppies, olives, sunflowers, coconuts, castor, cacao or peanuts; the marrow family, such as pumpkins, cucumbers or melons; fibre plants such as cotton, flax, hemp or jute; citrus fruits such as oranges, lemons, grapefruits or tangerines; vegetables such as spinach, lettuce, asparagus, cabbage species, carrots, onions, chillies, tomatoes, potatoes, or capsicums; the laurel family such as avocado, Cinnamonium or camphor; and tobacco, nuts (such as walnut), coffee, egg plants, sugar cane, tea, pepper, grapevines, hops, the banana family, latex plants and ornamentals. Also important are forage crops such as grasses and legumes.

In an embodiment plants include fibre plants, grain crops, legume crops, pulse crops, vegetables and fruit, more particularly, cotton, maize, sorghum, sunflower, lucerne, various legumes especially soybean, pigeon pea, mung bean and chickpea, tomatoes, okra and like plants.

In an embodiment plants include ornamental plants. By way of example these ornamental plants may be orchids, roses, tulips, trees, shrubs, herbs, lawns and grasses, bulbs, vines, perennials, succulents, house plants.

The present invention encompasses applying a compound, insecticidal composition or an extract comprising a γ-pyrone in a carrier (such as non-polar solvent, polar solvent, oil, water or any carrier product) to a plant affected by the pest or its surroundings, or to an animal affected by the pest. Treatment can include use of a non-polar solvent-based formulation, oil-based formulation, a water-based formulation, a residual formulation, wettable powder, dry powder and the like. In some embodiments, the compound, insecticidal composition or an extract comprising a γ-pyrone can be applied directly as plant material such as dried ground plant material as a powder. In some embodiments, combinations of formulations can be employed to achieve the benefits of different formulation types. The compound, insecticidal composition or an extract comprising a γ-pyrone may be added to the carrier or, in the case of a liquid formulation, the carrier may have been used to extract the SPCs, e.g., chloroform, methanol, water and combinations thereof.

In an embodiment the formulation is an oil-based formulation which may further comprise a surfactant.

In an embodiment the formulation is an oil-based formulation and the oil is a C₁₉-C₂₇ hydrocarbon.

In an embodiment the formulation comprises a γ-pyrone in an organic solvent such as an alcohol, ketone, aldehyde or sulfoxide. In some embodiments, suitable organic solvents can be selected from the group consisting of pentane, cyclopentane, hexane, cyclohexane, benzene, toluene, 1,4-dioxane, chloroform, diethyl ether, dichloromethane, tetrahydrofuran, ethyl acetate, acetone, dimethyl formamide, acetonitrile, dimethyl sulfoxide, nitromethane, propylene carbonate, n-butanol, isopropanol, n-propanol, ethanol, methanol, formic acid, acetic acid, hexafluoroisopropanol, trifluoroacetic acid and combinations thereof. In particular, the formulation comprises a γ-pyrone in alcohol.

In an embodiment the formulation includes a methanolic extract from the genus Podolepis, Gonystylus and combinations thereof. In an embodiment the formulation includes an ethanolic extract from the genus Podolepis, Gonystylus and combinations thereof.

In an embodiment the formulation comprises a γ-pyrone in low molecular weight oil such as crude and refined cotton seed oil or canola oil. Other oils include white oils, DC Tron oil (nC 21 and nC 24 oils), Canopy oil (nC27 oil), Biopest oil (nC 24 oils), dormant oil or summer oil, as known in the horticultural industry. Most of these oils are nC₁₉-nC₂₇ but other hydrocarbons having an acceptable toxicological profile may be used. There are number of such products in the market that are suitable for use with the present invention. These include Sunspray® oil, tea tree oil, and Sunspray® Ultra Fine manufactured by the Sun Refining and Marketing Company.

The petroleum spray oil may be used in conjunction with suitable agronomically-acceptable diluents and/or carriers and with other additives common in the art such as emulsifiers, wetting agents, surfactants, stabilisers, spreaders or the like.

In an embodiment the formulation includes an aqueous solution comprising an γ-pyrone.

In an embodiment the formulation includes a γ-pyrone in a low hydrocarbon solvent such as hexane.

In an embodiment the formulation includes a fraction of a crude extract comprising an γ-pyrone.

In an embodiment the formulation includes a fraction of a crude extract from the genus Podolepis, Gonystylus and combinations thereof.

In an embodiment the formulation includes a mixture of fractions of a crude extract from the genus Podolepis, Gonystylus and combinations thereof.

The term “carrier” as used herein means a liquid or solid material, which can be inorganic or organic and of synthetic or natural origin, with which the active compound is mixed or formulated to facilitate application of a compound, insecticidal composition, extract comprising a γ-pyrone according to the invention or an SPC which is applied to a locus to be treated, or to facilitate its storage, transport and/or handling. In general, any of the materials customarily employed in formulating insecticides are suitable.

The term “locus” as used herein refers to a place to which a composition according to the invention or an SPC is applied. It includes application to an individual plant, a group of plants such as a plant and/or its surrounds, an animal individually or in a group and the region in which plants may be planted or in which animals may congregate, as well application directly to an insect or insects and/or the vicinity in which they are located.

The compound, insecticidal composition or extract comprising a γ-pyrone of the present invention can be employed alone or in the form of mixtures with such solid and/or liquid dispersible carrier vehicles and/or other known compatible active agents such as pesticides, or acaricides, nematicides, fungicides, bactericides, rodenticides, herbicides, fertilisers, growth-regulating agents, etc., if desired, or in the form of particular dosage preparations for specific application made therefrom, such as solutions, emulsions, suspensions, powders, pastes, and granules which are thus ready for use.

The compound, insecticidal composition or extract comprising a γ-pyrone of the present invention can be formulated or mixed with, if desired, conventional inert insecticide diluents or extenders of the type usable in conventional pest control agents, e.g., conventional dispersible carrier vehicles in the form of solutions, emulsions, suspensions, emulsifiable concentrates, spray powders, pastes, soluble powders, dusting agents, granules or foams.

Typical emulsifiers that may be suitable for use in the compound, insecticidal composition or extract of the invention, include, but are not limited to, light molecular weight oils (e.g., canola, cottonseed, groundnut, corn, germ, olive, castor and sesame oils), and non-anionic, anionic and cationic surfactants. Blends of any of the above emulsifiers may also be used in the compound, insecticidal composition or extract of the present invention.

Typical non-ionic surfactants include ethoxylated alkanols, in particular ethoxylated fatty alcohols and ethoxylated oxoalcohols, such as ethoxylated lauryl alcohol, ethoxylated isotridecanol, ethoxylated cetyl alcohol, ethoxylated stearyl alcohol, and esters thereof, such as acetates; ethoxylated alkylphenols, such as ethoxylated nonylphenyl, ethoxylated dodecylphenyl, ethoxylated isotridecylphenol and the esters thereof, e.g., the acetates alkylglucosides and alkyl polyglucosides, ethoxylated alkylglucosides; ethoxylated fatty amines, ethoxylated fatty acids, partial esters, such as mono-, di- and triesters of fatty acids with glycerine or sorbitan, such as glycerine monostearate, glycerine monooleate, sorbitanmonolaurate, sorbitanmonopalmitate, sorbitanmonostearate, sorbitan monooleate, sorbitantristearate, sorbitan trioleate; ethoxylated esters of fatty acids with glycerine or sorbitan, such as polyoxyethylene glycerine monostearate, polyoxyethylene sorbitanmonolaurate, sorbitanmonopalmitate, polyoxyethylene sorbitanmonostearate, polyoxyethylene sorbitan monooleate, polyoxyethylene sorbitantristearate, polyoxyethylene sorbitan trioleate; ethoxylates of vegetable oils or animal fats, such as corn oil ethoxylate, castor oil ethoxylate, tallow oil ethoxylate; ethoxylates of fatty amines, fatty amides or of fatty acid diethanolamides.

Typical anionic surfactants include salts, in particular, sodium, potassium calcium or ammonium salts of alkylsulfonates, such as lauryl sulfonate, isotridecylsulfonate, alkylsulfates, in particular fatty alcohol sulfates, such as lauryl sulfate, isotridecylsulfate, cetylsulfate, stearylsulfate, aryl- and alkylarylsulfonates, such as napthylsulfonate, dibutylnaphtylsulfonate, alkyldiphenylether sulfonates such as dodecyldiphenylether sulfonate, alkylbenzene sulfonates such as cumylsulfonate, nonylbenzenesulfonate and dodecylbenzene sulfonate; sulfonates of fatty acids and fatty acid esters; sulfates of fatty acids and fatty acid esters; sulfates of ethoxylated alkanols, such as sulfates of ethoxylated lauryl alcohol; sulfates of alkoxylated alkylphenols; alkylphosphates and dialkylphosphates; dialkylesters of sulfosuccinic acid, such as dioctylsulfosuccinate, acylsarcosinates, fatty acids, such as stearates, acylglutamates, ligninsulfonates, low molecular weight condensates of naphthalinesulfonic acid or phenolsulfonic acid with formaldehyde and optionally urea;

Typical cationic surfactants include quaternary ammonium compounds, in particular alkyltrimethylammonium salts and dialkyldimethylammonium salts, e.g., the halides, sulfates and alkylsulfates.

In some embodiments, the compound, insecticidal composition or extract can be combined with one or more insecticides or pesticides. In some embodiments, the compound, insecticidal composition or extract can be combined with one or more synthetic insecticides or pesticides. In one embodiment, the insecticide or pesticide is selected from one or more of endosulfan, dicofol, chlorpyrifos, dimethoate, disulfoton, omethoate, parathion, phorate, profenofos, sulprofos, thiometon, aldicarb, carbaryl, beta-cyfluthrin, deltamethrin, esfenvalerate, fenvalerate, fluvalinate, lamda-cyhalothrin, chlorfluazuron, piperonyl butoxide, and petroleum spray oils. In another embodiment, the pesticide is a biological pesticide selected from a nuclear polyhedrosis virus and/or a plant extract known to be anti-feedant of pests. In yet another embodiment, the insecticide or pesticide is used at a reduced label rate. For example, the insecticide or pesticide may be used at half or one-third of the label rate.

The compound, insecticidal composition or extract of the present invention can be used to control insect pests by either treating a host directly or treating an area in which the host will be located. For example, the host can be treated directly by using a spray formulation, which can be applied to a plant individually or when grouped, such as an agricultural crop.

The formulation of the present invention may further comprise other formulation auxiliaries known in the art of agrochemical formulations in customary amounts. Such auxiliaries include, but are not limited to, antifreeze agents (such as but not limited to glycerine, ethylene glycol, propylene glycol, monopropylene glycol, hexylene glycol, 1-methoxy-2-propanol, cyclohexanol), buffering agents (such as but not limited to sodium hydroxide, phosphoric acid), preserving agents (such as but not limited to derivatives of 1,2-benzisothiazolin-3-one, benzoic acid, sorbic acid, formaldehyde, a combination of methyl parahydroxybenzoate and propyl parahydroxybenzoate), stabilising agents (such as but not limited to acids, preferably organic acids, such as dodecylbenzene sulfonic acid, acetic acid, propionic acid or butyl hydroxyl toluene, butyl hydroxyl anisole), thickening agents (such as but not limited to heteropolysaccharide and starches), and antifoaming agents (such as but not limited to those based on silicone, particularly polydimethylsiloxane). Such auxiliaries are commercially available and known in the art.

In an embodiment, the present invention uses fractions, SPCs and crude extracts from the genus Podolepis, Gonystylus and combinations thereof formulated to control cotton pests.

Typically, an extract can be obtained by added a solvent to a plant sample to provide a mixture. The mixture is then agitated such as by sonication and/or maceration. The mixture is then filtered and transferred to a separating funnel for solvent extraction. The bilayer formed during solvent extraction is then separated and the solvent is removed for example under pressure to result in at least two fractions of extract.

Method

As described above, the present invention provides a method of controlling one or more insect pests, the method comprising treating a locus with an insecticidally-effective amount of a compound, insecticidal composition comprising of one or more γ-pyrone compound/s of the present invention, or with an insecticidal composition comprising one or more extracts from the genera Podolepis, Gonystylus and combinations thereof comprising one or more secondary plant compounds (SPCs) of the present invention by eliciting insecticidal activity and/or repelling the insect pest and/or deterring the insect pest from laying eggs and/or influencing the position of egg laying and/or deterring the insect pest from feeding on a plant.

It would be appreciated by a skilled addressee that any suitable amount of a compound, insecticidal composition or extract can be applied to control insect pests. In certain embodiments, the method comprises treating a locus of an extract comprising an γ-pyrone at a concentration of less than about 20 w/v %, less than about 15 w/v %, less than about 10 w/v %, less than about 5 w/v %, less than about 3 w/v %, less than about 2 w/v %, less than about 1 w/v %, less than about 0.5 w/v % and less than about 0.25 w/v %.

In one embodiment, the method comprises treating a locus with a compound, insecticidal composition or an extract comprising a γ-pyrone at a concentration of between about 0.25 and about 20 w/v %, between about 0.25 and about 15 w/v %, between about 0.25 and about 10 w/v %, between about 0.25 and about 5 w/v %, between about 0.25 and about 3 w/v %, preferably between about 0.25 and about 2 w/v % and more preferably between about 0.25 and about 1 w/v %.

It would be appreciated by a skilled addressee that any suitable amount of SPC can be applied to control insect pests. In certain embodiments, the method comprises treating a locus with an SPC (i.e., active ingredient) at a concentration of less than about 20 w/v %, less than about 15 w/v %, less than about 10 w/v %, less than about 5 w/v %, less than about 3 w/v %, less than about 2 w/v %, less than about 1 w/v %, less than about 0.5 w/v % and less than about 0.25 w/v %.

In certain embodiments, the method comprises treating a locus of an SPC (i.e., active ingredient) at a concentration of between about 0.001 and about 20 w/v %, between about 0.001 and about 15 w/v %, between about 0.001 and about 10 w/v %, between about 0.001 and about 5 w/v %, between about 0.001 and 3 w/v %, between about 0.001 and 2 w/v %, between about 0.001 and 1 w/v %, between about 0.005 and 0.5 w/v % and between about 0.001 and 0.1 w/v %.

In certain embodiments, the method comprises treating a locus of an SPC (i.e., active ingredient) at a concentration of between 1 and about 30000 ppm, between about 30 and about 30000 ppm, between about 50 and about 30000 ppm, between about 100 and about 30000 ppm, between about 150 and about 30000 ppm, between about 200 and about 30000 ppm, between about 300 and about 30000 ppm, between about 300 and about 25000 ppm, between about 300 and about 16000 ppm, between about 300 and about 15000 ppm, between about 300 and about 12000 ppm, between about 3000 and about 12000 ppm.

Preferably, the compound, insecticidal composition, extract and formulation of the present invention are suitable for killing the insect (i.e., insecticidal activity). Without being bound by theory, the present inventors believe the γ-pyrone when applied to the plant or insect penetrates the insect's cuticle layers or is ingested to kill the insects. Alternatively, the residue of the extract on the plant can repel insects or deter the insects from laying eggs or feeding. The formulation can kill or deter insect egg laying or feeding within 3-4 days of application to the insect or the target crop.

The present inventors have surprisingly found that the γ-pyrone of the present invention can affect at least two ion channels of the insect pest, in contrast to known insecticides, which typically only affect a single ion channel as part of its mode of action. For example, dichlorodiphenyltrichloroethane (DDT) and pyrethoids typically target sodium channels of insect pests.

In certain embodiments, the γ-pyrone affects at least two neuronal ion channels of the insect pest, preferably selected from the group consisting of sodium, potassium and chloride ion channels. In some embodiments, the γ-pyrone causes an efflux of sodium and potassium ions. In some embodiments, the γ-pyrone causes an influx of chloride ions.

Without being bound by any one theory, the present inventors believe that the insecticidal activity of the γ-pyrone/s of the present invention is provided by having a γ-pyrone moiety “core” in combination with at least one optionally substituted aliphatic chain on any one of the C2, C3, C5 or C6 carbons of the γ-pyrone “core”.

Typically, the compound, insecticidal composition, extract, fractions, crude or

SPC (i.e., active ingredients) of the present invention is dissolved in a carrier (such as an organic solvent or organic solvent/water mix) and applied to the crops infested with the target insects. It would be appreciated by a skilled addressee that any suitable rate of application of γ-pyrone can be applied to control insect pests. The rate of application of the compound, insecticidal composition or extract of the invention is typically between about 1-500 L of compound, insecticidal composition, extract or SPC in a carrier per hectare, preferably about 60-120 L of compound, insecticidal composition, extract or SPC in a carrier per hectare, more preferably about 100 L of compound, insecticidal composition, extract or SPC in a carrier per hectare. The treatment may involve follow-up sprays if desired. In certain embodiments, the treatment involves at least two, three or four sprays at 3-28 day intervals, 3-14 day intervals, preferably 7 day intervals.

The present Inventors have surprisingly and advantageously found that the γ-pyrone of the present invention has minimal effect against beneficial species such as pollinators including the European honey bee (Apis mellifera).

The indiscriminate use and excessive reliance on broad-spectrum insecticides can result in increased insecticide-resistance and the re-emergence of previously managed insect pests, contributing to environmental pollution, food residues and unacceptable risks to human health and biodiversity. Broad-spectrum insecticides can also kill beneficial predators and pollinators which is undesirable.

In Australia, Helicoverpa armigera insecticide resistance is tightly managed by the cotton industry by the adoption of Insecticide Resistance Management Strategies, which are promoted and continually updated by the Cotton Research & Development Corporation (CRDC) and specific to geographical regions.

Currently there are 185 registered products, spanning 17 chemical insecticide groups. To reduce the development of resistance by insect pests such as Helicoverpa armigera, many of these chemical groups can only be applied once or twice per growing season. Resistance to indoxacard, avermectins, rynaxypyr® (ry-nax-ipier) and organophospahates are relatively low, however resistances to bifenthrin have increased to 40% and resistances to general pyrethroids has increased to 90% in recent years.

Helicoverpa armigera alone has shown resistance to at least 47 active ingredients, in some cases this has resulted in cross-resistance to chemicals which work at similar mode-of-action sites, reducing the effective products growers can rotate through. Additionally, secondary cotton pests can develop multiple resistances to insecticides.

The present inventors have surprisingly found that in some embodiments, the γ-pyrone compound, insecticidal composition, extracts and formulations of the present invention have shown selectivity against insect pests. In particular, the γ-pyrone compound of the present invention has insecticidal activity against aphids and two-spotted spider mites, with minimal effect against Helicoverpa. Further, the γ-pyrone compound has minimal effect against beneficial species such as pollinators including the European honey bee (Apis mellifera) as discussed above.

This shows the compounds, insecticidal compositions and extracts of the present invention can be used while avoiding potential insecticide resistance by certain insect pests such as Helicoverpa which is a known issue in the agricultural industry as discussed above.

Compounds, insecticidal compositions and extracts of the present invention can be used to compliment integrated pest management and resistance management programs of growers while providing an environmentally sensitive option.

In an embodiment, the plant structure used to obtain the extract is the leaves, stems, roots, pods, seeds and a combination of any of the plant parts. In some embodiments, the plant structure used to obtain the extract is at the pre-flower stage. In some embodiments, the plant structure used to obtain the extract is at the post-flower stage. In some embodiments, the plant structure used to obtain the extract is during the flowering stage. These may be used as fractions or crude extracts in formulations such as methanol, water or any other carriers to control chewing or sap sucking pests through repellent action, suppression of egg laying, deterrence of feeding and direct contact activity.

Botanically, the genus Podolepis is an annual and perennial herb having woolly appearance with fine septate hairs and often with minute glandular hairs, or glabrescent. The plant typically has basal and cauline leaves. Inflorescence occurs on one or a few terminal heads and the plant has solitary or contracted to elongated cyme. The terminal heads are campanulate to hemispherical shaped, usually with scale leaves at the peduncle apex merging with involucral bracts. The outer florets are typically yellow. Podolepis can be found distributed around the world with 18 species known to date and is endemic to Australia.

Botanically, the genus Gonystylus, is a southeast Asian genus of about 30 species of hardwood trees also known as ramin, melawis (Malay) and ramin telur (Sarawak). Ramin is native to Malaysia, Singapore, Indonesia, Brunei, the Philippines, and Papua New Guinea, with the highest species diversity on Borneo. It is related to Arnhemia, Deltaria, Lethedon and Solmsia. Ramin is a medium-sized tree, typically reaching a height of about 24 m with a straight, clear (branch-free), unbuttressed bole about 18 m long and 60 cm in diameter. The trees are slow-growing, occurring mainly in swamp forests.

In certain embodiments, the insecticidal compositions of the present invention display activity against insect pests, which may include economically important agronomic, forest, greenhouse, nursery, ornamentals, food and fibre, public and animal health, domestic and commercial structure, household, and stored product pests. Insect pests include insects selected from the orders Coleoptera, Diptera, Hymenoptera, Lepidoptera, Mallophaga, Homoptera, Acari, Hemiptera, Orthoptera, Thysanoptera, Dermaptera, Isoptera, Anoplura, Siphonaptera, Trichoptera, Coleoptera, etc., particularly Hemiptera and Trombidiformes.

Larvae of the order Lepidoptera include, but are not limited to, armyworms, cutworms, loopers, and heliothines in the family Noctuidae Spodoptera frugiperda JE Smith (fall armyworm); S. exigua Hübner (beet armyworm); S. litura Fabricius (tobacco cutworm, cluster caterpillar); Mamestra configurata Walker (bertha armyworm); M brassicae Linnaeus (cabbage moth); Agrotis ipsilon Hufnagel (black cutworm); A. orthogonia Morrison (western cutworm); A. subterranea Fabricius (granulate cutworm); Alabama argillacea Hübner (cotton leaf worm); Trichoplusia ni Hübner (cabbage looper); Pseudoplusia includens Walker (soybean looper); Anticarsia gemmatalis Hübner (velvetbean caterpillar); Hypena scabra Fabricius (green cloverworm); Heliothis virescens Fabricius (tobacco budworm); Pseudaletia unipuncta Haworth (armyworm); Athetis mindara Barnes and Mcdunnough (rough skinned cutworm); Euxoa messońa Harris (darksided cutworm); Earias insulana Boisduval (spiny bollworm); E. vittella Fabricius (spotted bollworm); Helicoverpa armigera Hübner (American bollworm); H. zea Boddie (corn earworm or cotton bollworm); Melanchra picta Harris (zebra caterpillar); Egira (Xylomyges), curialis Grote (citrus cutworm); borers, casebearers, webworms, coneworms, and skeleton izers from the family Pyralidae Ostrinia nubilalis Hübner (European corn borer); Amyelois transitella Walker (naval orangeworm); Anagasta kuehniella Zeller (Mediterranean flour moth); Cadra cautella Walker (almond moth); Chilo suppressalis Walker (rice stem borer); C. partellus (sorghum borer); Corcyra cephalonica Stainton (rice moth); Crambus caliginosellus Clemens (corn root webworm); C. teterrellus Zincken (bluegrass webworm); Cnaphalocrocis medinalis Guenee (rice leaf roller); Desmia funeralis Hübner (grape leaffolder); Diaphania hyalinata Linnaeus (melon worm); D. nitidalis Stoll (pickleworm); Diatraea grandiosella Dyar (southwestern corn borer), D. saccharalis Fabricius (sugarcane borer); Eoreuma loftini Dyar (Mexican rice borer); Ephestia elutella Hübner (tobacco (cacao) moth); Galleria mellonella Linnaeus (greater wax moth); Herpetogramma licarsisalis Walker (sod webworm); Homoeosoma electellum Hulst (sunflower moth); Elasmopalpus lignosellus Zeller (lesser cornstalk borer); Achroia giisella Fabricius (lesser wax moth); Loxostege sticticalis Linnaeus (beet webworm); Orthaga thyrisalis Walker (tea tree web moth); Maruca testulalis Geyer (bean pod borer); Plodia interpunctella Hübner (Indian meal moth); Scirpophaga incertulas Walker (yellow stem borer); Udea rubigalis Guenee (celery leaftier); and leafrollers, budworms, seed worms, and fruit worms in the family Tortricidae Acleris gloverana Walsingham (Western blackheaded budworm); A. variana Fernald (Eastern blackheaded budworm); Archips argyrospila Walker (fruit tree leaf roller); A. rosana Linnaeus (European leaf roller); and other Archips species, Adoxophyes orana Fischer von Rósslerstamm (summer fruit tortrix moth); Cochylis hospes Walsingham (banded sunflower moth); Cydia latiferreana Walsingham (filbertworm); C. pomonella Linnaeus (coding moth); Platynota flavedana Clemens (variegated leafroller); P. stultana Walsingham (omnivorous leafroller); Lobesia botrana Denis & Schiffermiiller (European grape vine moth); Spilonota ocellana Denis & Schiffermiiller (eyespotted bud moth); Endopiza viteana Clemens (grape berry moth); Eupoecilia ambiguella Hübner (vine moth); Bonagota salubńcola Meyrick (Brazilian apple leafroller); Grapholita molesta Busck (oriental fruit moth); Suleima helianthana Riley (sunflower bud moth); Argyrotaenia spp.; Choristoneura spp.

Selected other agronomic pests in the order Lepidoptera include, but are not limited to, Alsophila pometaria Harris (fall cankerworm); Anarsia lineatella Zeller (peach twig borer); Anisota senatoria J. E. Smith (orange striped oakworm); Antheraea pernyi Guerin-Meneville (Chinese Oak Tussah Moth); Bombyx mori Linnaeus (Silkworm); Bucculatńx thurbeńella Busck (cotton leaf perforator); Colias eurytheme Boisduval (alfalfa caterpillar); Datana integerrima Grote & Robinson (walnut caterpillar); Dendrolimus sibiricus Tschetwerikov (Siberian silk moth), Ennomos subsignaria Hübner (elm spanworm); Erannis tiliaria Harris (linden looper); Euproctis chrysorrhoea Linnaeus (browntail moth); Harrisina americana Guerin-Meneville (grapeleaf skeletonizer); Hemileuca oliviae Cockrell (range caterpillar); Hyphantria cunea Drury (fall webworm); Keiferia lycopersicella Walsingham (tomato pinworm); Lambdina fiscellaria fiscellaria Hulst (Eastern hemlock looper); L. fiscellaria lugubrosa Hulst (Western hemlock looper); Leucoma salicis Linnaeus (satin moth); Lymantria dispar Linnaeus (gypsy moth); Manduca quinquemaculata Haworth (five spotted hawk moth, tomato hornworm); M. sexta Haworth (tomato hornworm, tobacco hornworm); Operophtera brumata Linnaeus (winter moth); Paleacrita vernata Peck (spring cankerworm); Papilio cresphontes Cramer (giant swallowtail, orange dog); Phryganidia californica Packard (California oakworm); Phyllocnistis citrella Stainton (citrus leafminer); Phyllonorycter blancardella Fabricius (spotted tentiform leafminer); Pieris brassicae Linnaeus (large white butterfly); P. rapae Linnaeus (small white butterfly); P. napi Linnaeus (green veined white butterfly); Platyptilia carduidactyla Riley (artichoke plume moth); Plutella xylostella Linnaeus (diamondback moth); Pectinophora gossypiella Saunders (pink bollworm); Pontia protodice Boisduval & Leconte (Southern cabbageworm); Sabulodes aegrotata Guenee (omnivorous looper); Schizura concinna J. E. Smith (red humped caterpillar); Sitotroga cerealella Olivier (Angoumois grain moth); Thaumetopoea pityocampa Schiffermuller (pine processionary caterpillar); Tineola bisselliella Hummel (webbing clothesmoth); Tuta absoluta Meyrick (tomato leafminer); Yponomeuta padella Linnaeus (ermine moth); Heliothis subflexa Guenee; Malacosoma spp. and Orgyia spp. Of interest are larvae and adults of the order Coleoptera including weevils from the families Anthribidae, Bruchidae, and Curculionidae (including, but not limited to: Anthonomus grandis Boheman (boll weevil); Lissorhoptrus oryzophilus Kuschel (rice water weevil); Sitophilus granarius Linnaeus (granary weevil); S. oryzae Linnaeus (rice weevil); Hypera punctata Fabricius (clover leaf weevil); Cylindrocopturus adspersus LeConte (sunflower stem weevil); Smicronyx fulvus LeConte (red sunflower seed weevil); S. sordidus LeConte (gray sunflower seed weevil); Sphenophorus maidis Chittenden (maize billbug)); flea beetles, cucumber beetles, rootworms, leaf beetles, potato beetles, and leafminers in the family Chrysomelidae (including, but not limited to: Leptinotarsa decemlineata Say (Colorado potato beetle); Diabrotica virgifera virgifera LeConte (western corn rootworm); D. barberi Smith & Lawrence (northern corn rootworm); D. undecimpunctata howardi Barber (southern corn rootworm); Chaetocnema pulicaria Melsheimer (corn flea beetle); Phyllotreta cruciferae Goeze (corn flea beetle); Colaspis brunnea Fabricius (grape colaspis); Oulema melanopus Linnaeus (cereal leaf beetle); Zygogramma exclamationis Fabricius (sunflower beetle)); beetles from the family Coccinellidae (including, but not limited to: Epilachna vańvestis Mulsant (Mexican bean beetle)); chafers and other beetles from the family Scarabaeidae (including, but not limited to: Popilliajaponica Newman (Japanese beetle); Cyclocephala borealis Arrow (northern masked chafer, white grub); C. immaculata Olivier (southern masked chafer, white grub); Rhizotrogus majalis Razoumowsky (European chafer); Phyllophaga crinita Burmeister (white grub); Ligyrus gibbosus De Geer (carrot beetle)); carpet beetles from the family Dermestidae; wireworms from the family Elatehdae, Eleodes spp., Melanotus spp.; Conoderus spp.; Limonius spp.; Agriotes spp.; Ctenicera spp.; Aeolus spp.; bark beetles from the family Scolytidae and beetles from the family Tenebhonidae.

Adults and immatures of the order Diptera are of interest, including leafminers Agromyza parvicornis Loew (corn blotch leafminer); midges (including, but not limited to: Contarinia sorghicola Coquillett (sorghum midge);Mayetiola destructor Say (Hessian fly); Sitodiplosis mosellana Gehin (wheat midge); Neolasioptera murtfeldtiana Felt, (sunflower seed midge)); fruit flies (Tephritidae), Oscinella frit Linnaeus (fruit flies), Bactrocera tryoni (Queensland fruit fly); maggots (including, but not limited to: Delia platura Meigen (seedcorn maggot); D. coarctata Fallen (wheat bulb fly); and other Delia spp., Meromyza americana Fitch (wheat stem maggot); Musca domestica Linnaeus (house flies); Fannia canicularis Linnaeus, F. femoralis Stein (lesser house flies); Stomoxys calcitrans Linnaeus (stable flies)); face flies, horn flies, blow flies, Chrysomya spp.; Phormia spp.; and other muscoid fly pests, horse flies Tabanus spp.; bot flies Gastrophilus spp.; Oestrus spp.; cattle grubs Hypoderma spp.; deer flies Chrysops spp.; Melophagus ovinus Linnaeus (keds); and other Brachycera, mosquitoes Aedes spp.; Anopheles spp.; Culex spp.; black flies Prosimulium spp.; Simulium spp.; biting midges, sand flies, sciands, and other Nematocera. Included as insects of interest are adults and nymphs of the orders Hemiptera and Homoptera such as, but not limited to, adelgids from the family Adelgidae, plant bugs from the family Miridae, cicadas from the family Cicadidae, leafhoppers, Empoasca spp.; from the family Cicadellidae, planthoppers from the families Cixiidae, Flatidae, Fulgoroidea, Issidae and Delphacidae, treehoppers from the family Membracidae, psyllids from the family Psyllidae, whiteflies from the family Aleyrodidae including Aleyrodes proletella (Cabbage whitefly, Kale whitefly, Brassica whitefly), aphids from the family Aphididae, phylloxera from the family Phylloxeridae, mealybugs from the family Pseudococcidae, scales from the families Asterolecanidae, Coccidae, Dactylopiidae, Diaspididae, Eriococcidae, Ortheziidae, Phoenicococcidae and Margarodidae, lace bugs from the family Tingidae such as olive lace bug (Froggattia oliviana), stink bugs from the family Pentatomidae, cinch bugs, Blissus spp.; and other seed bugs from the family Lygaeidae, spittlebugs from the family Cercopidae, squash bugs from the family Coreidae, and red bugs and cotton stainers from the family Pyrrhocoridae.

Agronomically important members from the order Homoptera further include, but are not limited to: Acyrthisiphon pisum Harris (pea aphid); Aphis craccivora Koch (cowpea aphid); Aphis fabae Scopoli (black bean aphid); Aphis gossypii (cotton aphid, melon aphid); A. maidiradicis Forbes (corn root aphid); A. pomi De Geer (apple aphid); A. spiraecola Patch (spirea aphid); Aulacorthum solani Kaltenbach (foxglove aphid); Chaetosiphon fragaefolii Cockerell (strawberry aphid); Diuraphis noxia Kurdjumov/Mordvilko (Russian wheat aphid); Dysaphis plantaginea Paaserini (rosy apple aphid); Eńosoma lanigerum Hausmann (woolly apple aphid); Brevicoryne brassicae Linnaeus (cabbage aphid); Hyalopterus pruni Geoffroy (mealy plum aphid); Lipaphis erysimi Kaltenbach (turnip aphid); Metopolophium dirrhodum Walker (cereal aphid); Macrosiphum euphorbiae Thomas (potato aphid); Myzus persicae Sulzer (peach-potato aphid, green peach aphid); Nasonovia ribisnigri Mosley (lettuce aphid); Pemphigus spp. (root aphids and gall aphids); Rhopalosiphum maidis Fitch (corn leaf aphid); R. padi Linnaeus (bird cherry-oat aphid); Schizaphis graminum Rondani (greenbug); Sipha flava Forbes (yellow sugarcane aphid); Sitobion avenae Fabricius (English grain aphid); Therioaphis maculata Buckton (spotted alfalfa aphid); Toxoptera aurantii Boyer Fonscolombe (black citrus aphid); and T. citricida Kirkaldy (brown citrus aphid); Adelges spp. (adelgids); Phylloxera devastatrix Pergande (pecan phylloxera); Bemisia tabaci Gennadius (tobacco whitefly, sweetpotato whitefly); B. argentifolii Bellows & Perring (silverleaf whitefly); Dialeurodes citri Ashmead (citrus whitefly); Trialeurodes abutiloneus (bandedwinged whitefly) and T. vaporariorum Westwood (greenhouse whitefly); Empoasca fabae Harris (potato leafhopper); Laodelphax striatellus Fallen (smaller brown planthopper); Macrolestes quadrilineatus Forbes (aster leafhopper); Nephotettix cinticeps Uhler (green leafhopper); N. nigropictus Stal (rice leafhopper); Nilaparvata lugens Stal (brown planthopper); Peregrinus maidis Ashmead (corn planthopper); Sogatella furcifera Horvath (white-backed planthopper); Sogatodes orizicola Muir (rice delphacid); Typhlocyba pomaria McAtee (white apple leafhopper); Erythroneoura spp. (grape leafhoppers); Magicicada septendecim Linnaeus (periodical cicada); lcerya purchasi Maskell (cottony cushion scale); Quadraspidiotus perniciosus Comstock (San Jose scale); Planococcus citri Risso (citrus mealybug); Pseudococcus spp. (other mealybug complex); Cacopsylla pyricola Foerster (pear psylla); Trioza diospyń Ash mead (persimmon psylla).

Agronomically important species of interest from the order Hemiptera include, but are not limited to: Acrosternum hilare Say (green stink bug); Anasa tristis De Geer (squash bug); Blissus leucopterus leucopterus Say (chinch bug); Corythuca gossypii Fabricius (cotton lace bug); Cyrtopeltis modesta Distant (tomato bug); Dysdercus suturellus Herrich-Schaffer (cotton stainer); Euschistus servus Say (brown stink bug); E. vańolańs Palisot de Beauvois (one-spotted stink bug); Graptostethus spp. (complex of seed bugs); Leptoglossus corculus Say (leaf-footed pine seed bug); Lygus lineolaris Palisot de Beauvois (tarnished plant bug); L. Hesperus Knight (Western tarnished plant bug); L. pratensis Linnaeus (common meadow bug); L. rugulipennis Poppius (European tarnished plant bug); Lygocoris pabulinus Linnaeus (common green capsid); Nezara viridula Linnaeus (southern green stink bug); Oebalus pugnax Fabricius (rice stink bug); Oncopeltus fasciatus Dallas (large milkweed bug); Pseudatomoscelis seriatus Reuter (cotton fleahopper).

Furthermore, embodiments of the present invention may be effective against Hemiptera such, Calocoris norvegicus Gmelin (strawberry bug); Orthops campestris Linnaeus; Plesiocońs rugicollis Fallen (apple capsid); Cyrtopeltis modestus Distant (tomato bug); Cyrtopeltis notatus Distant (suckfly); Spanagonicus albofasciatus Reuter (whitemarked fleahopper); Diaphnocoris chlorionis Say (honeylocust plant bug); Labopidicola allii Knight (onion plant bug); Pseudatomoscelis seriatus Reuter (cotton fleahopper); Adelphocoris rapidus Say (rapid plant bug); Poecilocapsus lineatus Fabricius (four-lined plant bug); Nysius ericae Schilling (false chinch bug); Nysius raphanus Howard (false chinch bug); Nezara viridula Linnaeus (Southern green stink bug); Eurygaster spp.; Coreidae spp.; Pyrrhocoridae spp.; Tinidae spp.; Blostomatidae spp.; Reduviidae spp.; and Cimicidae spp.

Also included are adults and larvae of the order Acari (mites) such as Aceria tosichella Keifer (wheat curl mite); Petrobia latens Müller (brown wheat mite); spider mites and red mites in the family Tetranychidae, Panonychus ulmi Koch (European red mite); Tetranychus urticae Koch (two spotted spider mite); (T. mcdanieli McGregor (McDaniel mite); T. cinnabarinus Boisduval (carmine spider mite); T. turkestani Ugarov & Nikolski (strawberry spider mite); flat mites in the family Tenuipalpidae, Brevipalpus lewisi McGregor (citrus flat mite); rust and bud mites in the family Ehophyidae and other foliar feeding mites and mites important in human and animal health, i.e., dust mites in the family Epidermoptidae, follicle mites in the family Demodicidae, grain mites in the family Glycyphagidae, ticks in the order Ixodidae. Ixodes scapularis Say (deer tick); /. holocyclus Neumann (Australian paralysis tick); Dermacentor variabilis Say (American dog tick); Amblyomma americanum Linnaeus (lone star tick); and scab and itch mites in the families Psoroptidae, Pyemotidae, and Sarcoptidae. Insect pests of the order Thysanura are of interest, such as Lepisma saccharina Linnaeus (silverfish); Thermobia domestica Packard (firebrat).

Agronomically-important species of interest from the order Thysanoptera (thrips) include but are not limited to: Frankliniella occidentalis (western flower thrips); F. occidentalis, Thrips simplex, Thrips palmi, Frankliniella tritici and Heliothrips haemorrhoidalis (greenhouse thrips).

In an embodiment, the insect pests are selected from cotton bollworm, native budworm, green mirids, aphids, green vegetable bugs, apple dimpling bugs, thrips (plaque thrips, tobacco thrips, onion thrips, western flower thrips), white flies and two spotted spider mites.

In an embodiment the insect pests of animals include fleas, lice, mosquitoes, flies, tsetse flies, ants, ticks, mites, silverfish and chiggers.

The insecticidal activity of the present invention may be tested against the insect pests at any stage of their lifecycle. For instance, in their early developmental stages, e.g., as larvae or other immature forms. The insects may be reared in either total darkness or natural light at from about 20° C. to about 30° C. and from about 30% to about 70% relative humidity. Methods of rearing insect larvae and performing bioassays are well known to one of ordinary skill in the art.

In some embodiments, the insecticidal effect is an effect wherein treatment causes at least about 10% of the exposed insect pests to die. In some embodiments, the insecticidal effect is an effect wherein causes at least about 25% of the insect pests to die.

In some embodiments the insecticidal effect is an effect wherein treatment causes at least about 50% of the exposed insect pests to die. In some embodiments the insecticidal effect is an effect wherein treatment causes at least about 75% of the exposed insect pests to die. In some embodiments the insecticidal effect is an effect wherein treatment causes at least about 90% of the exposed insect pests to die. In some embodiments the insecticidal effect is an effect wherein treatment causes at least about 95% of the exposed insect pests to die. In some embodiments the insecticidal effect is an effect wherein treatment causes at least about 99% of the exposed insect pests to die. In some embodiments the insecticidal effect is an effect wherein treatment causes at least about 99.5% of the exposed insect pests to die. In some embodiments the insecticidal effect is an effect wherein treatment causes at least about 99.9% of the exposed insect pests to die.

Beneficial insects that can be conserved by the present invention, i.e., are not significantly harmed by exposure to it include (1) predatory beetles Harmonia arcuata (Fabricius) adults, Diomus notescens (Blackburn) adults, Coccinella repanda (Thunberg) adults, Dicranolauis bellulus (Guerin); (2) predatory bugs such as Geocoris lubra (kirkaldy adults, Cermatulus nasalis (Westwood) adults, Nabis capsiformis (Germar), (3) Spiders especially salticidae, Araneus spp. Oxypes spp. and (Parasitoids) Pterocormus promissorius (Erichson), Heteropelma scaposum (Morley), Netelia producta (Brulle) and (4) pollinators such as Honey bees (Apis) especially Apis mellifera (European honey bee), Apis mellifera capensis East African lowland honey bee), Apis koschevnikovi (Koschevnikov's honey bee), Apis nigrocincta, Apis cerana (Easter honey bee or Asiatic honey bee), Apis cerana indica (Indian honey bee) and Apis cerana nuluensis.

Embodiments of the invention are also directed to making an improved insect control agent by identifying one or more fractions in a complex agent, screening the one or more fractions using the methods disclosed herein, and characterising the one or more fractions as having a positive or negative effect on potential activity against a target insect.

In some embodiments, one or more fractions in a complex agent (such as, for example, an essential oil) can be isolated using fractionation techniques including, for example, differential solvent extraction, fractional distillation, fractional crystallisation, fractional freezing, dry fractionation, detergent fractionation, solvent extraction, supercritical CO₂ fractionation, vacuum distillation, column chromatography, reverse-phase chromatography, high-pressure liquid chromatography, and the like. These methods are known to those of skill in the art and practised widely. Vacuum distillation is preferred, because it is relatively simple to employ and does not require the use of solvents.

In some embodiments, one or more fractions of a complex agent can be isolated by column chromatography using silica or alumina solid support. An organic solvent, including for example, alkanes such as hexanes and petroleum ether, toluene, methylene chloride (or other halogenated hydrocarbons), diethyl ether, ethyl acetate, acetone, alcohol, acetic acid, and the like, can be used alone or in combination as the column solvent, or mobile phase. In some embodiments, the complex agent is fractionated by column chromatography using an increasing concentration of a polar solvent as eluting solvent. Methods of performing column chromatography and solvents common for its use are well known in the art.

In some embodiments, the SPCs can be isolated by solvent extraction. For example, an extract can be combined with an organic solvent, including, for example an organic solvent such as methanol, acetic acid, acetone, acetonitrile, benzene, 1-butanol, 2-butanol, 2-butanone, t-butyl alcohol, carbon tetrachloride, chlorobenzene, chloroform, cyclohexane, 1,2-dichloroethane, diethyl ether, diethylene glycol, diglyme (diethylene glycol dimethyl ether), 1,2-dimethoxy-ethane (glyme, DME), dimethylether, dimethyl-formamide (DMF), dimethyl sulfoxide (DMSO), dioxane, ethanol, ethyl acetate, ethylene glycol, glycerin, heptane, hexamethylphosphoramide (HMPA), hexamethylphosphorous triamide (HMPT), hexane, methyl t-butyl ether (MTBE), methylene chloride, JV-methyl-2-pyrrolidinone (NMP), nitromethane, pentane, petroleum ether (ligroine), 1-propanol, 2-propanol, pyridine, tetrahydrofuran (THF), toluene, triethyl amine, water, heavy water, o-xylene, m-xylene, and/or-xylene. Other organic solvents known to those of skill in the art can also be employed.

The mixture of the SPC and the organic solvent can then be combined with an extraction solvent that is not miscible in the organic solvent, including, for example, water, ethanol, and methanol. This combination is shaken vigorously in a glass container such as a separatory funnel for several minutes, then allowed to settle into separate phases for several minutes. The lower, denser phase is then allowed to drain from the separatory funnel. The organic phase can then be repeatedly re-extracted with the extraction solvent to further partition compounds that are soluble in the extraction solvent from the organic phase. The volume of the organic phase and the extracted phase can then be reduced in volume using rotary evaporation, yielding two separate fractions of the SPC.

In some embodiments, the method for identifying an improved agent against a target insect can include the identification of the compounds present in either a complex agent or individual isolated fractions of a complex agent and screening of the ingredient compounds for their activity. Identification of the compounds can be performed by analysing the complex agent or an isolated fraction thereof by High-Performance Liquid Chromatography (HPLC) or gas chromatography (GC) coupled with Mass Spectrometry (MS). Ingredient compounds can also be identified by first enriching or purifying individual ingredients to homogeneity using techniques including, for example, differential solvent extraction, fractional distillation, vacuum distillation, fractional crystallization, fractional freezing, dry fractionation, detergent fractionation, solvent extraction, supercritical CO₂ fractionation, column chromatography, reverse-phase chromatography, high-pressure liquid chromatography, and the like. Enriched or purified components can be identified using spectroscopy techniques, including, for example, infrared (IR) spectroscopy, Raman spectroscopy, nuclear magnetic resonance spectroscopy (NMR), and the like.

Some embodiments relate to the use of chemical derivatives or analogues of chemicals identified to generate an improved agent against a target insect. Chemical derivatives of the chemicals identified can include compounds derivatised with an inorganic or organic functional group. In some embodiments, the chemical derivative is a compound derivatised with an organic functional group. In some embodiments, the organic functional group can be an alkyl group. In some embodiments, the organic functional group can be a methyl, ethyl, propyl, butyl, ceryl, decyl, heptyl, hexyl, myricyl, myristyl, nonyl, octyl, palmityl, pentyl, stearyl, isopropyl, isobutyl, lignoceryl, pentacosyl, heptacosyl, montanyl, nonacosyl, pentan-2-yl, isopentyl, 3-methylbutan-2-yl, tert-pentyl, neopentyl, undecyl, tridecyl, pentadecyl, margaryl, nonadecyl, arachidyl, henicosyl, behenyl, tricosyl, cyclobutyl, cyclopropyl group, or the like. In some embodiments, the organic functional group can be an aryl group. In some embodiments, the organic functional group can be a phenyl or biphenyl-4-yl group.

In some embodiments, the improved agent against a target insect includes a chemical derivative that is a halogenated derivative of a compound identified. In some embodiments, the chemical derivative is a fluorinated, chlorinated, brominated, or iodinated derivative.

In some embodiments, the improved agent against a target insect includes a chemical derivative that is an alkenylated derivative of a compound. In some embodiments, the improved agent against a target insect includes a chemical derivative that is a glycosylated derivative of a compound or the like which improves water solubility. In some embodiments, the chemical derivative is an oleylated, allylated, isopropenylated, vinylated, prenylated, glycosylated, or phytylated derivative.

In some embodiments, the improved agent against a target insect includes a chemical derivative that is a hydroxylated derivative of a compound identified. In some embodiments, the improved agent against a target insect includes a chemical derivative that is a thiolated derivative of a compound identified. In some embodiments, the improved agent against a target insect includes a chemical derivative that is a carboxylated derivative of a compound identified. In some embodiments, the improved agent against a target insect includes a chemical derivative that is an amidated derivative of a compound identified. In some embodiments, the improved agent against a target insect includes a chemical derivative that is an esterified derivative of a compound identified. In some embodiments, the improved agent against a target insect includes a chemical derivative that is acylated derivative of a compound identified. In some embodiments, the improved agent against a target insect includes a chemical derivative that is a sulfonated derivative of a compound identified.

In some embodiments, the improved agent against a target insect includes a chemical derivative that is derivatised by introducing a homologue of a substituent group.

In some embodiments, the improved agent against a target insect includes a chemical derivative that is derivatised by moving a substituent around a ring to a different position.

In some embodiments, the efficacy of a test composition can be determined by conducting studies with insect pests. For example, the efficacy of a test composition for killing an insect pest, altering its propensity to feed or lay eggs, or the like, an insect can be studied using controlled experiments wherein insect pests are exposed to the test composition. In some embodiments, the toxicity of a test composition against an insect pest can be studied using controlled experiments wherein insects are exposed to the test composition. The efficacy of a test composition can also be determined with beneficial and predatory species.

In some embodiments, the formulations consist of an emulsifier of high solvency and the capacity to form stable emulsions of the total formulation in water and a “carrier” oil which may also have pesticidal properties. A preferred “carrier” oil is an esterified vegetable oil.

In an embodiment, the insect pest is a pest of an animal and the method comprises applying a compound, insecticidal composition or extract comprising an γ-pyrone to the animal. In an embodiment the animal may be dogs, cats, cattle, sheep, horses, goats, pigs, chicken, guinea pig, donkey, duck, bird, water buffalo, camel, reindeer, goose, llama, alpaca, elephant, deer, rabbit, mink, chinchilla, hamster, fox, emu and ostrich.

In an embodiment the method comprises treating a habitat, for instance, the habitat of any one or more of the animals identified above.

In certain embodiments, the LC₅₀ value of the compound, insecticidal composition or extract is less than about 3000 ppm (i.e., 0.3%), less than about 2500 ppm, less than about 2000 ppm, less than about 1500 ppm, less than about 1000 ppm, less than about 500 ppm, less than about 200 ppm, less than about 100 ppm, less than about 50 ppm and preferably less than about 30 ppm.

In certain embodiments, the LC₅₀ value of the compound, insecticidal composition or extract is between about 10 and 3000 ppm, between about 10 and 2500 ppm, between about 10 and 2000 ppm, between about 10 and 1500 ppm, between about 10 and 1000 ppm, between about 10 and 500 ppm, between about 10 and 200 ppm, between about 10 and 100 ppm, between about 10 and 50 ppm and preferably between about 10 and 30 ppm.

In certain embodiments, the LC₉₅ value of the compound, insecticidal composition or extract is less than about 1500 ppm (i.e., 0.15%), less than about 1000 ppm, less than about 500 ppm, less than about 200 ppm, less than about 100 ppm, less than about 50 ppm, less than about 30 ppm and preferably less than about 10 ppm.

In certain embodiments, the LC₉₅ value of the compound, insecticidal composition or extract is between about 10 and 1500 ppm, between about 10 and 1000 ppm, between about 10 and 800 ppm, between about 10 and 500 ppm and preferably between about 100 and 300 ppm.

In use, the method of the present invention can be performed by spraying a dispersion solution. Sprays can be applied from spray containers such as a can, a bottle or other container, either by means of a pump or by releasing it from a pressurised container, e.g., a pressurised aerosol spray can. Such spray compositions can take various forms, for example, sprays, mists, foams, fumes or fog. Such spray compositions thus can further comprise propellants, foaming agents, etc. as the case may be.

In another embodiment of the present invention there is provided a kit for on-the-shelf sale, the kit comprising a spraying means, a container means which may or not be integral with the spraying means, predetermined amounts of the constituent ingredients of the spray formulation (e.g., the γ-pyrone, the carrier, the surfactant, if applicable), and instructions for preparing the formulation for use.

Typical propellants include, but are not limited to, methane, ethane, propane, butane, isobutane, butene, pentane, isopentane, neopentane, pentene, hydrofluorocarbons, chlorofluorocarbons, dimethyl ether, and combinations thereof.

In other embodiments, the method can be performed using a cream, ointment, emollient, paste, gel, powder, solid and combinations thereof.

### Example 1: Plant Extracts

Approach 1

Plant samples (aerial parts) from identified living plants were collected and placed in labelled paper bags then dried in an oven at 40° C. for 7 days after which the material was ground and stored in appropriate containers at room temperature. The original sample of Podolepis jaceoides in flower was obtained from Mt Annan Botanic Gardens, Mt Annan NSW, Australia. The plants were subsequently grown at Western Sydney University's Hawkesbury campus from seeds obtained from a commercial supplier, Nindethana Australian Seeds, Albany Western Australia; and from seeds collected from this crop.

Technical grade methanol and Milli-Q (ultrapure) water was used for preparation of the extracts for testing. Approximately 25 g of each sample was added to a 1:1 mixture of methanol:chloroform (250 mL). The mixtures were sonicated for 60 min and macerated (24 h), vacuum filtered and the filtrate transferred into a separating funnel. A small volume of water (ca. 25 mL) was added to the mixture in order to create a bilayer system consisting of a non-polar chloroform layer (N) and a polar aqueous-methanol layer (P). These two layers were separated into pre-weighed round bottom flasks. The fractions were evaporated to dryness using a rotary evaporator (P) or evaporation in a fume hood (N). Each fraction was tested separately.

Once the active ingredient had been determined, a suitable organic solvent such as methanol, ethanol, acetone or binary (two solvent) system was used.

Approach 2

Extracts were prepared from dried, harvested flowers of Podolepis jaceoides (plant #68) grown at Western Sydney University (WSU). The flowers were ground to a fine powder using a waring blender and extracted with pure methanol (20 g ground plant in 200 mL pure methanol), shaken on a Ratec platform mixer for 24 h, sonicated for 80 min and then filtered through a glass filter funnel fitted with a Whatman no 1 filter paper. The filtrate formed the “methanol extract”.

Next, 1.0% w/v emulsions were prepared by taking a certain weight from the extracts in order to prepare sufficient volume for the treatment of the three test organisms, two-spotted spider mite, cotton aphid and Helicoverpa. The dry extracts were initially dissolved in acetone, sonicated for 5 min before diluting with distilled water containing 200 ppm of the surfactant Triton X-100™ to prepare a 1.00% w/v emulsion from each sample.

The stock solutions were then serially diluted with Triton X-100/water to prepare concentrations of 0.200, 0.100, 0.050 and 0.0125% w/v. These lower concentrations were tested against TSM and cotton aphid; 1.0% was tested against Helicoverpa.

### Example 2: Target Pests

Aphis gossypii Glover (Hemiptera: Aphidoidea), commonly known as the cotton or melon aphid, is a world-wide pest with a very wide host range (see, e.g., www.cabi.org/isc/datasheet/6204). It also is a vector of numerous viruses. Aphis gossypii (susceptible strain) (Hemiptera: Aphididae), was established as a culture from material supplied by Dr Grant Herron, NSW Department of Primary Industries, Menangle NSW, Australia. Aphids were reared on potted Gossypium hirsutum L. (Malvaceae) grown from non-insecticide-treated conventional cotton seed, supplied by Dr Robert Mensah, NSW Department of Primary Industries, Narrabri NSW, Australia. The culture was maintained in a temperature-controlled greenhouse chamber set at 27±3° C. and 55±10% RH (relative humidity) and natural light. Only young adult females were selected for bioassay.

Tetranychus urticae Koch, (Acari: Tetranychidae), commonly known as two-spotted spider mite is a cosmopolitan, phytophagous species, and an important agricultural pest in many temperate and sub-tropical countries. It is highly polyphagous, and feeds primarily on plant foliage. Tetranychus urticae Koch UWS 1 (organophosphate-susceptible) strain, originally obtained from Dr Grant Herron, NSW

Department of Primary Industries, Menangle NSW, Australia, but had been maintained at WSU Hawkesbury campus for approximately 18 years. They were reared on potted French beans, Phaseolus vulgaris var Redland Pioneer (in a constant temperature room maintained at 25±2° C., 65±5% RH and 14 h D: L photoperiod. The culture was reared on potted dwarf French bean (Phaseolus vulgaris L. var. Redland Pioneer) plants grown in a composted pinebark-based potting medium in a large (7.0 m (1)×6.0 m (w)×4.0 m (h)), pesticide-free, constant temperature room (28-30° C., 50% RH, 18:6, D:L). Only young gravid female two-spotted mites were selected for bioassay.

Helicoverpa armigera (Hubner) (Lepidoptera: Noctuidae), commonly known as the cotton bollworm or as heliothis, is a widespread species, with an extensive host range (see, e.g., https://www.cabi.org/isc/datasheet/26757). It typically feeds selectively on high protein plant parts, such as flowers, buds and fruits. Helicoverpa armigera was obtained as fresh eggs from AgBiTech Pty. Ltd, Glenvale QLD, Australia, or CSIRO Agriculture and Food, Cotton Research Institute, Myall Vale NSW, Australia.

Eggs (50-75) were transferred with a fine camel hair brush onto 90 mm Whatman No. 1 filter paper partially moistened with distilled water and thin slices from the artificial medium supplied by AgBiTech were placed on the filter paper as a source of food for the hatching caterpillars. The eggs were left to hatch under laboratory conditions of 25±3° C. and 65±10% RH. Hatching occurred within 24 h and bioassays were carried out on neonate larvae with an average weight of 4.12 mg.

### Example 3: Bioassays

For the two-spotted spider mite, screening of each sample was conducted on 20-40 adult female mites, which were evenly distributed on 1-3 French bean leaf discs (25 mm diam.) contained in 90 mm diameter Petri dishes. The leaf discs were placed with their underside uppermost on moist absorbent cotton wool. Water was added to the dishes daily to prevent desiccation of the leaf discs and preventing the mites from escaping the leaf disc.

A 3.0 mL aliquot was applied to each Petri dish with a Potter precision spray tower as described by Herron et al., Potter spray tower bioassay of selected citrus pests to petroleum spray oil, Journal of the Australian Entomological Society 34, 253-263, 1995.

The average weight of the solution sprayed on each dish was calculated to be 5.385 mg/cm² or 0.05385 mg/cm² active ingredient (a.i.). Dishes were retained under laboratory conditions (24±2° C., 50±15% RH) for post-treatment observations. Mortality was recorded 24 h and 48 h after treatment (HAT). Death was recognised by the absence of movement when the test organisms were mechanically stimulated by prodding with a brush.

For the cotton aphid, parthenogenetic adult female aphids were collected from the cultures on cotton plants. Fifteen adults were transferred using a fine camel hair brush onto the lower side of a respective leaf disc 50 mm diameter mounted on 1.0% w/v agar in a plastic insect cage measuring 50 mm diameter×15 mm height plastic insect breeding 50 mm diameter×15 height (SPL Life Sciences, Korea).

The cage had a lid with a hole (15 mm diameter) which was covered with fine mesh; the lid was removed just prior to spraying. Aliquots (3 mL) of the 1% w/v extracts were applied with a Potter Spray Tower for each treatment, as described above, and the spray was allowed to partially dry before the cage was covered with its lid and the sides of the cage sealed with Parafilm M®.

Dishes were retained under laboratory conditions (24±2° C., 50±15% RH) for post-treatment observations. Mortality counts were conducted at 24 and 48 HAT. Absence of the aphid movement when prodded with a fine brush was taken as the criterion of death.

For Helicoverpa, neonate larvae 4-12 h after hatching were transferred individually to a cotton plant leaf disc (35 mm diameter) mounted with its lower side uppermost on 1% agar in an Easy Grip Tissue Culture Dish dimensions 35×10 mm (Corning Incorporated, Corning NY, USA). Only one neonate was transferred to each dish (because initial investigations treating small groups of neonates prior to separating them resulted in larval damage due to cannibalism), and four of these dishes were placed in a large Petri dish 90 mm diameter and sprayed with 3 mL aliquots using a Potter Spray Tower, as described above. Thus, each replicate comprised 4 neonates.

Following spraying, the small dishes were covered with a perforated plastic sheet and then placed in plastic insect cages previously described for aphid bioassays. The number of dishes sprayed per sample was 4-10. Dishes were retained under laboratory conditions (24±2° C., 50±15% RH) for post-treatment observations. Mortality counts were conducted at 24 and 48 HAT. Absence of the caterpillar movement when prodded with a fine brush was taken as the criterion of death.

For each batch of investigations, control treatments were conducted, with methodology identical to other treatments. The control treatment solutions comprised 3 mL aliquots of 200 ppm Triton X-100 in distilled water and acetone or hexane at the same concentration as the test solutions. Investigations were discarded if control mortality exceeded 15%. Treatment mortality was calculated and is presented as corrected mortality, to account for any control mortality (Abbott WS., A method of computing the effectiveness of an insecticide. Journal of Economic Entomology, 18, 265-267, 1925).

### Example 4: Results of Insecticidal Activity Testing

Table 1 shows initial experimental data, demonstrating that the efficacy of the non-polar extract of P. jaceiodes was highly efficacious against cotton aphid and two-spotted spider mite, but not against Helicoverpa. The polar extract showed substantially less efficacy against these target species. It showed almost immediate activity after application at efficacious concentrations, with signs of intoxication in target organisms within the first hour after treatment (HAT), and resulted in 100% mortality within a few hours, and no offspring. However, the polar fraction showed substantially lower efficacy against the target species than the non-polar fraction, particularly against cotton aphid.

A subsequent investigation showed 100% mortality in cotton aphid at 0.25% a.i. (Table 2).

A further assessment of another P. jaceoides N extract (of flowers) using only methanol as the solvent resulted in very high mortality in cotton aphid, high mortality in two-spotted spider mite and no mortality in Helicoverpa (Table 3). For cotton aphid 100% mortality of cotton aphid occurred in the 0.05 and 0.20% treatments, whereas there was 84.4% mortality of TSM at the 0.20% w/v. The estimated LC₅₀ and LC₉₅ values for cotton aphid 0.014% (0.004-0.021), (viz. 140 [40-210] ppm) and 0.051% (0.039-0.112) (510 [390-1120 ppm], respectively.

TABLE 1
Activity of P. jaceoides extracts (N and P) against test organisms: adult female
two-spotted spider mite (TSM), mixed age cotton aphid and neonate Helicoverpa armigera

| | | | | Corrected | Corrected | |
|---|---|---|---|---|---|---|
| Plant | Conc. | Target | No. | mortality (%) | mortality (%) | |
| extract | (% w/v) | organism | treated | 24 HAT | 48 HAT | Comments |
| Podolepis | 0.5 | TSM | 42 | 75.00 | 100.00 | No eggs |
| jaceoides | 1.0 | | 30 | 100.00 | 100.00 | No eggs |
| N | 0.25 | Cotton | 42 | 75.00 | 100.00 | No nymphs |
| | 1.0 | aphid | 55 | 100.00 | 100.00 | No nymphs |
| | 1.0* | Helicoverpa | 6 | 0.00 | 0.00 | Healthy |
| Podolepis | 1.0* | TSM | 25 | 72.00 | 76.00 | Sluggish |
| jaceoides | 1.0* | Cotton | 55 | 34.29 | 66.67 | Survivors OK |
| P | | aphid | | | | |

*no lower concentrations tested;
HAT = hours after treatment;
N = non-polar fraction;
P = polar fraction

TABLE 2
Activity of P. jacoides N fraction against test organisms:
adult female two-spotted spider mite (TSM), mixed age
cotton aphid and neonate Helicoverpa armigera

| Plant | Efficacy against two- | Efficacy against | Efficacy against |
|---|---|---|---|
| extract | spotted spider mite | cotton aphid | Helicoverpa |
| 68N | 1.0% w/v | 1.0% w/v | 1.0% w/v |
| | 100% mortality | 100% mortality | 15.8% mortality |
| | 0.5% w/v | 0.5% w/v | 0.5% NA |
| | 87% mortality | 100% mortality | |
| | 0.25% w/v | 0.25% w/v | 0.25% NA |
| | 60% mortality | 100% mortality | |
| | (LC₅₀ <0.25%) | (LC₅₀ <<0.25%) | (LC₅₀ >>1.0%) |

TABLE 3
Activity of Podolepis jaceoides methanol extract against
the three target arthropod species: two-spotted spider mite
(TSM), cotton aphid and Helicoverpa armigera, 48 HAT
and estimated LC₅₀ and LC₉₅ values (ppm) for cotton
aphid and estimated LC₅₀ and LC₉₅ values (ppm).

| P. jaceoides | TSM | | Cotton aphid | | Helicoverpa | |
|---|---|---|---|---|---|---|
| N % concen- | No. | No. | No. | No. | No. | No. |
| tration w/v | treated | dead | treated | dead | treated | dead |
| Control | 23 | 2 | 38 | 2 | 9 larvae | 0.0 |
| 0.025 | 18 | 6 | 45 | 35 | 9 larvae | 0.0 |
| 0.050 | 8 | 4 | 41 | 38 | treated with | |
| 0.100 | 15 | 8 | 42 | 42 | 1.0% w/v | |
| 0.200 | 32 | 27 | 44 | 44 | concentration | |

| | |
|---|---|
| LC₅₀ (95% CL) | 140 |
| ppm* | (40-210) |
| LC₉₅ (95% CL) | 510 |
| ppm* | (390-1120) |

*X² = 0.734

Heterogeneity of regressions was determined by the Pearson χ2 characteristic, and if the significance level was <0.150, a heterogeneity factor was used in the calculation of the confidence limits. This enabled estimates of LC values and their 95% confidence limits (CL) of which LC₅₀ and LC₉₅ were selected as good representations of activity for a potential insecticide. Analysis was performed using the program IBM SPSS Statistics 25.

### Example 5: Pot Trial to Assess P. Jaceoides Methanol Extract Against Cotton Aphid

A replicated pot trial also demonstrated high efficacy of the P. jaceoides methanol extract against cotton aphid.

Twelve potted cotton plants were grown under controlled glass house conditions (26-28° C. and 60±10% RH) for three weeks until they reached two fully expanded true leaves. Each pot contained a single plant. They were relocated for three days among potted plants heavily infested with cotton aphids to enable build of infestations on their leaves. The newly infested pots were randomly divided into two groups, each of six plants.

A 1.0% w/v concentration of the P. jaceoides methanol extract in water containing 200 ppm Triton X-100 was prepared, as well as a control that contained all contents except the extract, as previously described. One group of plants was sprayed with the 1.0% w/v extract and the other with the control emulsion. A 500 mL hand sprayer was used to apply 45 mL of each treatment to the six plants. Each plant was sprayed separately to cover upper and lower surfaces of all leaves until run off; this was approximately 7.5 mL of treatment per plant.

Pre- and post-spray counts of aphids on one tagged leaf were made, with post-treatment counts at 24 HAT and 48 HAT. Observations were made at 2 HAT to determine any knockdown effects. As mortality had reached 100% by 48 HAT, the experiment was terminated. Plants were retained to 5 DAT to assess any phytotoxicity resulting from the treatment.

The data was analysed using the general linear model of analysis of variance (ANOVA). Each variable was visually tested for normality using Q-Q plot and Levene's test was used for testing the assumption of equality of error variance. The level of significance was set at P=0.05. In this case, however, the results were clear-cut and there was a single treatment and a control, so that a statistical analysis was not required.

The results are summarised in Table 4. At 24 HAT, there was mean aphid mortality of 97.37 (±SE. 2.162), with 100% mortality at 48 HAT on five of the six plants. It is possible that the other plant, on which >90% mortality was recorded at 48 HAT, was not thoroughly sprayed. There was negligible mortality in the control treatment at 24 and 48 HAT, with results of the treatment being highly significant (F_{1,11}=1888.475, P<0.001 and F_{1,11}=1603.362, P<0.001, respectively).

At the 24 HAT assessment, it was observed that many aphids on the extract-treated leaves were near death point whereas those on the control plants were normal. This trial confirms the laboratory bioassays that a non-polar or a methanol extract of P. jaceoides (labelled extract #68) has very high aphicidal activity.

TABLE 4
Efficacy of P. jaceoides methanol extract against cotton
aphid on potted cotton plants in greenhouse trial.

| | Pre- | 24 HAT | | | 48 HAT | | | |
|---|---|---|---|---|---|---|---|---|
| | treatment | Total | No. | % | Total | No. | % | |
| Treatment | count | number | Dead | mortality | number | Dead | mortality | Comments |
| Control | 88 | 88 | 0 | 0.00 | 98 | 0 | 0.00 | Normal, feeding, |
| | | | | | | | | nymphs present |
| | 31 | 31 | 1 | 3.23 | 52 | 1 | 1.92 | Normal, feeding, |
| | | | | | | | | nymphs present |
| | 82 | 150 | 0 | 0.00 | 180 | 0 | 0.00 | Normal, feeding, |
| | | | | | | | | nymphs present |
| | 97 | 113 | 0 | 0.00 | 132 | 0 | 0.00 | Normal, feeding, |
| | | | | | | | | nymphs present |
| | 64 | 111 | 0 | 0.00 | 118 | 0 | 0.00 | Normal, feeding, |
| | | | | | | | | nymphs present |
| | 54 | 75 | 0 | 0.00 | 85 | 0 | 0.00 | Normal, feeding, |
| | | | | | | | | nymphs present |
| Mean | 69.33 | 94.67 | | 0.54 | 110.83 | | 0.32 | |
| 1.0% P. | 54 | 97 | 96 | 98.97 | | | 100.00 | Survivors sick, sluggish |
| jaceoides | | | | | | | | at 24 HAT |
| methanol | 104 | 162 | 161 | 99.38 | | | 100.00 | Survivors sick, sluggish |
| extract | | | | | | | | at 24 HAT |
| | 101 | 172 | 172 | 100.00 | | | 100.00 | |
| | 44 | 82 | 71 | 86.59 | 83 | 71 | 85.55 | Possibly plant was not |
| | | | | | | | | fully sprayed many |
| | | | | | | | | survivors sick, sluggish |
| | | | | | | | | several nymphs |
| | 63 | 153 | 153 | 100.00 | | | 100.00 | |
| | 71 | 137 | 136 | 99.27 | | | 100.00 | Survivors sick, sluggish |
| | | | | | | | | at 24 HAT |
| Mean | 72.83 | 133.83 | | 97.37 | | | 97.59 | |

There were no signs of phytotoxicity in any plants, up to 5 HAT. This indicates that the P. jaceoides methanol extract had no phytotoxic effects under the conditions of the study.

Additionally, the extracts did not cause phytotoxicity in cotton or French bean plants when applied at much higher concentrations than those found to be effective. This result indicates that no crop damage is likely to arise with end-use insecticides derived from these botanical extracts of the present invention.

### Example 6: Field Trial to Assess Efficacy of Podolepis Jaceoides Methanol Extract Against Cotton Aphid

Materials and Methods

A trial was conducted on an irrigated commercial Bollgard II cotton crops (Sicot 74 variety) at the Australian Cotton Research Institute (ACM) in Narrabri NSW, Australia. The cotton crop used for the study comprised mature plants close to cut-out and were contaminated with Aphis gossypii from infested leaves collected from a nearby commercial cotton field at Yarral, Narrabri NSW, Australia.

The treatment plots were arranged in a randomised complete block design with 3 replicates per treatment. Each replicated plot measured 2 m (2 rows) wide and 1 m long with 2 m (rows) buffer between replicated plots. Three plants in each treatment replicate with terminals infested with aphids were randomly selected and terminals tagged for pre- and post-treatment assessments. The following treatments were evaluated against Aphis gossypii adults and nymphs: (1) 1.0% v/v P. jaceoides methanol extract, (2) 125 mL/ha Clothianidin (Shield), (3) Control.

The P. jaceoides methanol extract was dissolved in 10 mL acetone, then diluted with 100 ppm Triton-X 100 water. The control was sprayed with 100 ppm Triton-X 100 in water only.

Foliar application of each treatment was performed, applying the control first, then the plant extract, and finally the industry standard. Each treatment was applied to run-off using a small hand-held pressure sprayer fitted with flat fan nozzles delivering a droplet size of 200 μm (equivalent to field application of 100 L/ha). The decision to apply the treatment was made based on the IPM Guidelines and CottonLogic recommended economic threshold of 50% of plant terminals infested.

The number of A. gossypii and beneficial species (mainly predatory insects) were assessed by visually counting A. gossypii adults and nymphs and beneficials on the upper and undersides of leaves from the 3-4 nodes below the tagged plant terminals. Pre-treatment counts were made 24 h before treatment and post treatment counts on 1, 2, 5, 6, 7, 8, 9, 12 and 14 days after treatment (DAT).

The data for both A. gossypii adults and nymphs as well as predatory insects were each initially expressed as numbers per terminal. Data were calculated as percentage reduction of population compared to the pre-treatment count.

Means of data on population reduction were compared using one-way ANOVA, after confirming normality, using SPSS v21. Significance was normally set at 5% (α=0.05), and when there was significance, means were separated using Duncan's Multiple range test.

The data are presented in Table 5. At 1 DAT and 2 DAT, there were significantly reduced cotton aphid populations (P_{2,9}=0.047; P_{2,9}=0.001, respectively) in the P. jaceoides extract and bifenthrin treatments compared with the control, but there was no difference between them.

At 5 DAT, there were no significant differences at the 5% level but were at 10% (P_{2,9}=0.087) between treatments, with the plant extract being superior to the control, but no other differences. At 6 DAT, 7 DAT and 14 DAT, there were no differences between any of the treatments, although there was a trend towards P. jaceoides extract being superior.

A range of beneficial species were recorded during the trial period. The most common species were spiders, ladybirds (adults and larvae), pirate bugs and hover flies. Comparison between treatments was difficult. First, some data (e.g., mummified aphids in Control at 1 DAT) were a result of activities prior to the trial commencing. Second, higher numbers of aphid predators in the Control at 5-6 DAT is likely to reflect previous higher aphid numbers. In general, numbers of beneficial species were low for the early stages of the trial but had generally built up in all treatments (including the control) by 9 DAT.

The trials had untreated buffer rows where beneficial species could have resided prior to moving into the trial site. It was late in the season (when beneficial species are generally in high numbers) and most other surrounding cotton crops had been harvested, making the trial site attractive.

Thus, the data on beneficial insects and other species are somewhat variable, with insufficient data points to make any detailed assessment. Nevertheless, there was no evidence of any of the chemical treatments (including P. jaceoides extract) adversely impacting beneficial species.

TABLE 5
Summary of results from field trial assessing efficacy of P. jaceoides
extract against cotton aphid. Data show percentage differences in aphid
populations at different timepoints following application of a single
spray of P. jaceoides extract at 1.0% and a comparative application
of the industry standard clothianidin at 125 mL/ha.

| | | % Reduction from pre-treatment count (mean of 3 plants) | | | | | |
|---|---|---|---|---|---|---|---|
| Treatment | Plot | 1 DAT | 2 DAT | 5 DAT | 6 DAT | 7 DAT | 14 DAT |
| P. jaceoides | 1 | 70.5 | 93.2 | 86.4 | 72.7 | 75.0 | 79.5 |
| extract | 2 | 85.7 | 100 | 100 | 100 | 100 | 50.0 |
| | 3 | 72.7 | 81.8 | 100 | 100 | 100 | 68.2 |
| | 4 | 21.7 | 78.3 | 95.7 | 95.7 | 87.0 | 65.2 |
| | Mean | 62.65a | 88.33a | 95.53a# | 95.53 | 90.50 | 65.73 |
| | (SE) | (14.06) | (5.03) | (3.21) | (3.21) | (6.01) | (6.08) |
| Clothianidin | 1 | 59.6 | 55.1 | 75.0 | 84.6 | 96.3 | 97.8 |
| | 2 | 28.6 | 92.9 | 78.6 | 64.3 | 38.1 | 78.6 |
| | 3 | 48.9 | 64.4 | 97.8 | 97.8 | 95.6 | 77.8 |
| | 4 | 81.5 | 96.3 | 88.9 | 92.6 | 81.5 | 74.1 |
| | Mean | 54.65 | 77.18 | 85.08a, b | 84.83 | 77.88 | 82.08 |
| | (SE) | (11.02) | (20.52)a | (5.16) | (7.36) | (13.69) | (5.33) |
| Control | 1 | −2.3 | 41.9 | 69.8 | 90.7 | 79.1 | 74.4 |
| | 2 | −5.0 | −12.5 | 42.5 | 87.5 | 85.0 | 70.0 |
| | 3 | 37.5 | 41.7 | 83.3 | 66.7 | 41.7 | 16.7 |
| | 4 | 29.1 | 15.4 | 88.0 | 97.4 | 94.9 | 91.9 |
| | Mean | 14.83b | 21.63 | 70.90b | 85.58 | 75.18 | 63.25 |
| | (SE) | (10.82) | (12.97)b | (10.22) | (6.62) | (11.62) | (16.22) |

#not significant at 5%, but significant at 10%

### Example 7: Assessment of Acute Toxicity of P. jaceoides Methanol Extract Against Honey Bees

The acute toxicity of the P. jaceoides methanol extract to honey bees was assessed. Although other insects may be efficient pollinators, the European honey bee, Apis mellifera, is regarded as the most important pollinator of agricultural crops worldwide because of its abundance and amenity to human handling.

Materials and Methods

The laboratory-based bioassay was performed to assess the acute toxicity of the extracts against adult foraging workers of Apis mellifera. 3 mL aliquots of P. jaceoides extract were applied at 1.0% a.i. w/v via a Potter Spray Tower, using the methodology previously described for the preparation and application of this plant extract to test insects.

Bifenthrin (CAS No 82657-04-3) 97.0% technical (Batch 50118) was sourced from Dr. Ehrenstorfer GmbH D-86190 Augsburg, Germany. A 0.05% w/v a.i. concentration was prepared by dissolving 0.013 g bifenthrin in 1 mL acetone, sonicating for 5 min and then diluted in a 25 mL volumetric flask with 200 ppm Triton X-100 in distilled water. It was applied using a 3 mL aliquot of the 0.05% a.i via a Potter Spray Tower; this concentration was based on recommended label rate in cotton. The control comprised 5 mL acetone and water-Triton X-100 mixture only; two controls were conducted.

Apis mellifera foraging workers for bioassay were collected from a strong, healthy hive at Western Sydney University apiary, at Richmond NSW, Australia, by blocking the hive entrance for 1 min and collecting foragers with a sweep net.

They were immediately transferred to a mesh cage (25×33×33 cm) and maintained in the laboratory at 24° C., where they were fed ad libidum sugar:water 1:1 w/v from cotton wool placed on the mesh at the top of the cage until bioassay, which was undertaken within 1 h of bee collection. Bees for bioassay were randomly collected from the cage using a 120 mL plastic specimen tube, and anaesthetised with medical grade CO₂ for 30 s, then ten bees were placed on a 90 mm diameter Petri dish lined with filter paper. The dish with the bees was placed on the Potter Spray Tower stage, and the respective treatment applied, commencing with the control and finishing with bifenthrin treatment.

Immediately after treatment, the treated bees were gently transferred to 250 mL glass beakers, fine nylon mesh was fitted to the top with a rubber band, and the bees fed were sugar:water as above and maintained at 26° C. in very low light. Bee activity was regularly observed and recorded, at 10 min intervals until 420 min (viz. 7 HAT), then less frequently until 48 HAT. By this time, there was bee mortality in both controls, so the investigation was terminated. Data recorded were signs of intoxication, knockdown (K) and mortality (D).

The results are presented in Table 6. P. jaceoides extract was safe for honey bees, as measured by acute toxicity, and was greatly superior to the industry comparator bifenthrin. There was no mortality or knockdown at 36 HAT, by which time mortality had commenced in one of the control replicates. In contrast, in the bifenthrin treatment, knockdown commenced at 10 MAT (minutes after treatment), mortality commenced at 90 MAT, with 50% bee knockdown at between 45-50 MAT and 50% mortality at 240 MAT. By 480 MAT, there was 100% mortality. The only treatment in which signs of bee intoxication were observed was the bifenthrin treatment. Lack of coordination, disgorging of gut contents and hyperactivity of bees were all observed.

TABLE 6
Knockdown (K) and mortality (D) of worker
A. mellifera after application of Podolepis jaceoides
methanol extract and bifenthrin.

| Time | | Control 1 | Control 2 | P. jaceoides | Bifenthrin |
|---|---|---|---|---|---|
| min/h | | (n = 8) | (n = 10) | extract (n = 10) | (n = 10) |
| 10 | min | 0 | 0 | 0 | 1K |
| 20 | | 0 | 0 | 0 | 1K |
| 30 | | 0 | 0 | 0 | 2K |
| 40 | | 0 | 0 | 0 | 3K |
| 45 | | 0 | 0 | 0 | 4K |
| 50 | | 0 | 0 | 0 | 6K |
| 60 | | 0 | 0 | 0 | 6K |
| 70 | | 0 | 0 | 0 | 6K |
| 80 | | 0 | 0 | 0 | 6K |
| 90 | | 0 | 0 | 0 | 5K, 1D |
| 100 | | 0 | 0 | 0 | 3K, 3D |
| 110 | | 0 | 0 | 0 | 4K, |
| 120 | | 0 | 0 | 0 | 4K, |
| 130 | | 0 | 0 | 0 | 4K, |
| 140 | | 0 | 0 | 0 | 3K, 4D |
| 150 | | 0 | 0 | 0 | 3K, 4D |
| 160 | | 0 | 0 | 0 | 4K, 4D |
| 170 | | 0 | 0 | 0 | 4K, 4D |
| 180 | | 0 | 0 | 0 | 4K, 4D |
| 190 | | 0 | 0 | 0 | 4K, 4D |
| 200 | | 0 | 0 | 0 | 4K, 4D |
| 210 | | 0 | 0 | 0 | 4K, 4D |
| 220 | | 0 | 0 | 0 | 5K, 4D |
| 230 | | 0 | 0 | 0 | 5K, 4D |
| 240 | | 0 | 0 | 0 | 4K, 5D |
| 250 | | 0 | 0 | 0 | 3K, 6D |
| 260 | | 0 | 0 | 0 | 3K, 6D |
| 270 | | 0 | 0 | 0 | 3K, 6D |
| 280 | | 0 | 0 | 0 | 3K, 6D |
| 290 | | 0 | 0 | 0 | 3K, 6D |
| 300 | | 0 | 0 | 0 | 3K, 6D |
| 310 | | 0 | 0 | 0 | 3K, 6D |
| 320 | | 0 | 0 | 0 | 3K, 6D |
| 330 | | 0 | 0 | 0 | 1K, 8D |
| 340 | | 0 | 0 | 0 | 1K, 8D |
| 350 | | 0 | 0 | 0 | 1K, 8D |
| 360 | | 0 | 0 | 0 | 1K, 8D |
| 370 | | 0 | 0 | 0 | 1K, 8D |
| 380 | | 0 | 0 | 0 | 1K, 8D |
| 390 | | 0 | 0 | 0 | 0K, 9D |
| 400 | | 0 | 0 | 0 | 0K, 9D |
| 410 | | 0 | 0 | 0 | 0K, 9D |
| 420 | | 0 | 0 | 0 | 0K, 9D |
| 450 | | 0 | 0 | 0 | 0K, 9D |
| 480 | | 0 | 0 | 0 | 10D |
| 24 | h | 0 | 0 | 0 | — |
| 36 | h | 0 | 1 | 0 | — |
| 48 | h | 1D | 1 | 1D | — |

While this was a single investigation assessing acute dermal toxicity (but not oral toxicity), it indicated that P. jaceoides extract has limited acute toxicity to honey bees and should be relatively safe for application in flowering crops where honey bees may be foraging. It should be remembered that the concentrations applied were 1.0% w/v, possibly higher than typically required to be applied in field applications against target insect pests and also that under the conditions of the study, the bees were exposed directly to the spray applied by a Potter Spray Tower. This level of exposure is unlikely to regularly occur in the field.

### Example 8: Assessment of efficacy of P. Jaceoides Methanol Extract Against Queensland Fruit Fly and Cabbage White Fly

A topical application of 1.0% w/v P. jaceoides (labelled #68) flower methanol extract with a Potter Spray Tower, resulted in approximately 100% mortality of mixed sex of adult Queensland fruit fly (QFF) (Bactrocera tryoni, Diptera: Tephritidae) at 48 HAT, using the methodology previously described. Soon after treatment, flies were hyperactive and showed knock down at 20 MAT. However, at 0.5% w/v the extract did not show similar knock down and at 48 HAT only one fly out five died, with the rest remaining alive. All treatment controls caused 0.0% mortality 48 HAT.

Against cabbage white fly, Aleyrodes proletella (Hemiptera: Aleyrodidae), a 1.0% w/v P. jaceoides (labelled #68) flower methanol extract with a Potter Spray Tower resulted in 100% mortality at 30 MAT.

Materials and Methods

Southern Cross University supplied P. jaceoides (labelled #68) flower methanol extract (batch ARL181076).

Approximately 50 pupae of Queensland fruit fly were collected from a culture that had been inbred for a number of generations at Western Sydney University by Dr Markus Riegler. The pupae were transferred to cages 30×30×30 cm in a glasshouse chamber under conditions of 25° C. and 70% RH. Adults emerged after ˜5 days and recently emerged mixed sex adults were used for the bioassay.

Cabbage white fly has a global distribution and is a pest on various Brassica species (particularly kale Brassica oleracea var. sabellica). Specimens for bioassay were collected from a natural heavy infestation at Western Sydney on healthy potted kale plants. Once the kale plants were observed to contain a high numbers of adult whiteflies, leaves were gently cut and put inside a one 1 L Perspex beaker covered with muslin netting and fixed with a rubber band.

Queensland Fruit Fly Bioassays

3-5-day-old, mixed sex flies were transferred to a 1 L Perspex beaker. Each fly was transferred to the beaker by trapping it in a 20 mL glass beaker before being released inside the larger beaker which was then covered with muslin netting supported by a rubber band. The beaker containing the flies was anaesthetised using medical grade carbon dioxide until their movement was restricted. The batch of flies was divided into a control treatment (viz. all constituents in the emulsion except the #68 extract) and 1.0% w/v concentration of the #68 methanol extract. The treatment arena was a small plastic Petri dish 50×15 mm lined with a same diameter filter paper. 3 mL aliquots were applied with Potter Spray Tower to the petri dish containing the anaesthetised flies. The uncovered treated dish was transferred into a 500 mL glass beaker which was covered with muslin netting supported by a rubber band.

Kale White Fly Bioasssays

A 1 L Perspex beaker was used to transfer the whiteflies on freshly cut kale leaves into a deep freezer at −20° C. It was found out that ˜40 minutes inside the deep freezer was sufficient for restricting movement of the white flies to allow transferring and treatment with a Potter Tower application of a control and a #68 methanol extract treatment. A fine camel hair brush was used to transfer adult white flies to a filter paper which was lining the base of a small Petri dish 50×15 mm. A 3 mL aliquot was applied with Potter Spray Tower on a control (0.0%) and 1.0% w/v concentrations (3 separate dishes, repeated treatment). After application of the treatments, a piece of fresh kale leaf approx. 25 mm diam. was placed inside the Petri dish before covering it with its lid, which had a 15 mm diam. hole covered with fine mesh.

Results

The results are presented in Table 7 (Queensland fruit fly, QFF) and Table 8 (kale white fly). For QFF, one of five flies was convulsing, and all survived at 48 HAT in the 0.5% w/v treatment. However, in the 1.0% w/v treatment, 80% of treated flies died and two remained convulsing at 48 HAT in one container; in the other container, there was 100% mortality. However, there was occasional slight twitching of appendages in those flies otherwise dead. Interestingly, hyperactivity of flies was observed within several minutes of treatment. The QFF then dropped to the bottom of the beaker and were unable to resume flying, convulsing until death.

For kale white fly, 100% mortality occurred in all three treated plates, with mortality occurring within 30 MAT. Observation at 48 HAT confirmed mortality, not just knockdown.

TABLE 7
Queensland fruit fly mortality following treatment
with 3 mL aliquot with a Potter Spray Tower 48 HAT

| % Concen- | No. | No. | % | |
|---|---|---|---|---|
| tration w/v | treated | dead | Mortality | Comments |
| 0.0 (Control) | 6 | 0 | 0 | Flying inside the |
| | | | | beaker |
| 0.5 | 5 | 0 | 0 | One fly convulsing |
| 1.0 | 10 | 8 | 80 | 8 with slight |
| | | | | appendage movement, |
| | | | | 2 convulsing |
| 1.0 | 5 | 5 | 100 | All with slight |
| | | | | appendage movement |

TABLE 8
Kale white fly mortality following treatment with
3 mL aliquot with a Potter Spray Tower 48 HAT

| % Concen- | No. | No. | % | |
|---|---|---|---|---|
| tration w/v | treated | dead | Mortality | Comments |
| 0.0 (Control) | 9 | 0 | 0 | Normal behaviour |
| 0.0 | 8 | 0 | 0 | Normal behaviour |
| 0.0 | 6 | 0 | 0 | Normal behaviour |
| 1.0 | 5 | 5 | 100 | Wings extended, |
| | | | | no movement |
| 1.0 | 8 | 8 | 100 | Wings extended, |
| | | | | no movement |
| 1.0 | 15 | 15 | 100 | Wings extended, |
| | | | | no movement |

These results indicated that a methanol extract of #68 has a high efficacy against kale white fly and medium-high efficacy against Queensland fruit fly.

### Example 9: Investigation of Chemistry of Podolepis Jaceoides to Determine Active Constituents of Solvent Extracts

This Example had two objectives: 1) to elucidate the chemistry of insecticidal P. jaceoides extracts and 2) to identify active fractions/compounds by conducting bioassay-guided fractionations.

The stems (including leaves) and flowers of P. jaceoides, were harvested and evaluated separately. Once dried and ground, samples were extracted with methanol (1 L) by sonication (1 h) and maceration (24 h). Filtered extracts were lyophilised and partitioned between water (250 mL) and hexane (3×250 mL) in a separation funnel, followed by diethyl ether (3×250 mL) and ethyl acetate (3×250 mL) extraction. The resulting aqueous (AQ), hexane (Hex), diethyl ether (DE), and ethyl acetate (EA) fractions were lyophilised to generate four fractions.

Liquid chromatography-mass spectrometry (LCMS) analysis was performed on a Waters Acquity Xevo TQ triple quadruple mass spectrometer coupled to a binary pump, phometric diode array (PDA) detector and an autosampler (Waters, Milford, USA) with a 3 μL injection volume. Chromatographic separation was performed using a C18 column (Phenomenex kinetex 1.7 100 A, 150×2.10 mm) and ACN/H₂O (acetonitrile/water) gradient (with 0.1% formic acid in both mobile phases) employing a mobile phase gradient from 10% ACN to 95% ACN over 25 min then 95% ACN for 5 min at a flow rate of 0.2 mL/min.

Mass spectra were acquired in atmospheric pressure chemical ionisation (APCI) positive mode with a mass range of m/z (mass to charge ratio) 150-800 a.m.u. (atomic mass units) and diode array detection (200-500 nm) with a capillary voltage of 2.5 kV; cone voltage 10 V; probe temperature 350-375° C. and gas flow 300 L/h. The data were analysed by MassLynx software (Waters, Milford, USA).

Whole plant samples were extracted in 100% methanol (MeOH), sonicated for one 30 hour then steeped overnight at a ratio of 1:10 w/v (dry weight) then filtered prior to analysis. Fractions or pure compounds were analysed at 0.5 mg/mL in methanol (MeOH).

NMR Spectroscopy

NMR spectra were obtained on a Bruker Avance DRX-400. Mnova NMR software (Mestrelab, Santiago de Compostela, Spain) was used to analyse the spectral data. The ¹H NMR spectra were recorded at 400 MHz and the ¹³C NMR spectra at 100 MHz. The chemical shifts (δ) are expressed in parts per million (ppm) as δ values and the coupling constants (J) in Hertz (Hz). COSY, NOESY, HSQC and HMBC experiments were acquired using the standard Bruker pulse programs. The experiments were performed in deuterated solvents, chemical shifts were calibrated relative to: the methanol solvent peak (¹H δ3.31 and ¹³C δ49.00 ppm), the DMSO solvent peak (¹H δ2.50 and ¹³C δ39.52 ppm), or the chloroform solvent peak (¹H δ7.26 and ¹³C δ77.16 ppm).

Preparative HPLC fractionation for the P. jaceoides whole extract proceeded on the basis of LC-MS analysis and the bioassay results from the polar and non-polar fractionation.

Bioassays were conducted against the same three target organisms, namely two-spotted spider mite, cotton aphid and Helicoverpa, as previously described, with mortality counts taken at 24 and 48 HAT. The concentration was 1.0% w/v unless otherwise stated in Table 9. The data are expressed as corrected mortality. Furthermore, any signs of phytotoxicity on the treated plant material (leaf discs) were noted and recorded.

The results from the bioassays of the fractions are presented in Table 9. Several fractions of #68, particularly those derived from flowers (#68F_P (polar) and #68F_N (non-polar)) showed very high activity against TSM and cotton aphid, and fraction #44 showed very high activity against both two-spotted spider mite and Helicoverpa; other fractions showed very high activity only against spider mite.

Further data for cotton aphid were not collected for the HPLC fractions, as they were further fractionated to produce podopyrones. Interestingly, the waste (column wash) presumably containing longer chain compounds also showed very high activity against cotton aphid.

The inventors subsequently compared chromatograms of methanol extracts from seeds, flower heads, white petals (ray florets) of Western Sydney University-grown Podolepis jaceoides to determine presence of podopyrones in these different plant parts (not shown). A comparison of the whole flower methanolic extract to the seeds, flower heads and white petals chromatogram was made. The whole flower methanolic extract and the divided components, white petals, flower heads and seeds showed the presence of podopyrones (dominant large double UV peaks at around 16 and 17 min). The same column was used for the seeds, flower heads and white petals, so are comparable. The podopyrone peaks are present in seeds, flower heads and petals between 18-20 min.

TABLE 9
Activity of fractions of superior extracts against test organisms:
adult female two-spotted spider mite (TSM), mixed age cotton aphid
and neonate Helicoverpa armigera (S = stems, F = flowers).

| | Corrected percentage mortality | | | | | | |
|---|---|---|---|---|---|---|---|
| | | | Cotton | | | | |
| Sample | TSM | | aphid | | Helicoverpa | | |
| Fraction of | 24 | 48 | 24 | 48 | 24 | 48 | |
| P. jaceoides | HAT | HAT | HAT | HAT | HAT | HAT | Comments |
| S_P | 66.7 | 62.5 | 87.8 | 87.8 | 0.0 | 0.0 | Stem |
| S_N | 27.8 | 94.7 | 90.3 | 93.5 | 16.7 | 16.7 | Stem |
| F_P | 85.7 | 95.0 | 100.0 | 100.0 | 0.0 | 0.0 | Flowers |
| F_N | 94.1 | 94.1 | 100.0 | 100.0 | 0.0 | 0.0 | Flowers |
| Fraction of | | | | | | | Whole plant |
| P jaceoides | | | | | | | (stems and |
| S + F | | | | | | | flowers) |
| 4 | 4.3 | 4.3 | 1 | NA | 0.0 | 0.0 | |
| 21 | 0.0 | 0.0 | | NA | 0.0 | 0.0 | |
| 26 | 10.3 | 10.3 | | NA | 0.0 | 0.0 | |
| 30 | 31.3 | 38.1 | | NA | 0.0 | 0.0 | |
| 36 | 73.8 | 78.3 | | NA | 0.0 | 0.0 | |
| 40 | 80.4 | 80.4 | | NA | 0.0 | 0.0 | |
| 42 | 100.0 | 100.0 | | NA | 0.0 | 0.0 | |
| 44 | 100.0 | 100.0 | 100.0 | NA | 100.0 | 100.0 | |
| 53 + 54 | 100.0 | 100.0 | | NA | 0.0 | 0.0 | |
| 55 + 56 | 100.0 | 100.0 | | NA | 0.0 | 0.0 | |
| column | 95.6 | 95.6 | | NA | 0.0 | 0.0 | 1st |
| wash 0.12% | | | | | | | |
| column | 30.7 | 46.0 | 59.1 | 95.0 | NA | NA | Repeated 2nd |
| wash 0.12% | | | | | | | |
| column | 43.7 | 59.1 | 91.7 | 100.0 | 16.7 | 16.7 | Repeated 3rd |
| wash 0.12% | | | | | | | |
| Fraction of | | | | | | | 0.5 mL of |
| P. jaceoides | | | | | | | ethyl acetate |
| | | | | | | | added to the |
| | | | | | | | individual |
| | | | | | | | samples |
| AQ | 20.0 | 25.0 | 33.3 | 37.8 | NA | NA | |
| EA | 17.6 | 26.7 | 45.2 | 48.4 | NA | NA | |
| DE | 55.6 | 61.1 | 14.3 | 73.5 | NA | NA | |
| H:H | 55.6 | 65.2 | 42.9 | 58.7 | NA | NA | Hexane |
| HMeOH | 90.5 | 90.5 | 84.3 | 90.2 | NA | NA | |

Comparing the whole plant extract to the flower head extract, it appears that the podopyrones have a greater concentration in the flower heads, as other compound peaks become more dominant. This was also confirmed in the total ion count (TIC) (not shown), as fewer podopyrone ions were detected. The TIC of the seeds extracts (not shown) had a high presence of podopyrone total ions at 18.85 and 19.14 min. The TIC of the white petals (not shown) had a large number of podopyrone ions detected at 19.02 and 19.3 min. These results confirmed that the strategy of extracting seed heads of P. jaceoides was appropriate.

### Example 10: Identifying Active Constituents from Podolepis Jaceoides (Non-Polar) Extract

Table 9 shows efficacy data from numerous extract fractions from these three-plant species. The bioactive components are more concentrated in flowers than stems and leaves. Further, fraction 44 was the most active fraction.

Extraction and Purification of Active Metabolites from Podolepis Jaceoides

The aerial parts of plants were harvested and dried. 50 g of dried plant material was ground and extracted in 1:1 chloroform:methanol (250 mL) by sonication (1 h) and maceration (24 h). Filtered extracts were separated into polar (#68P) and non-polar (#68N) fractions in a separation funnel by the addition of water (ca. 75 mL) until two immiscible layers formed. The polar fraction was evaporated to dryness using a rotary evaporator and the non-polar extract was evaporated in a fume hood. Dried extracts were screened for insecticidal activity.

“Whole Plant Extract” for Preparative HPLC Fractionation

The flowering, dried aerial parts of P. jaceoides were collected from plants grown at Hawkesbury campus Western Sydney University and dried in a laboratory oven at 40° C. for 7 days, then ground and extracted (100 g dry weight) in 1:1 chloroform:methanol (1 L) by sonication (1 h) and maceration (24 h). The filtered extract (pore 4 sintered glass frit) was evaporated to dryness using a rotary evaporator to yield a dark green crude extract 16.6 g (16.6% yield, w/w).

HPLC Fractionation of Active Extracts

Preparative HPLC fractionation was performed on a Shimadzu LC-20AP system (Kyoto, Japan) equipped with a DGU-20A3 in-line vacuum degassing and SIL-20AHT auto injector and operated via Lab Solutions software. The crude extract was solubilised in MeOH and pre-adsorbed to C18 (Alltech, Davisil C18 bonded silica, 35-75 μm, 150 A) on a 1:2 gram ratio respectively and packed in to a stainless steel guard cartridge (Alltech, 10×30 mm).

Purification of Podopyrones from P. Jaceoides

The extract (2.5 g) was fractionated on a reversed-phase preparative C18 Luna 5 μm 100 A (150×21.2 mm) column (Phenomenex, Lane Cove, Australia) with a binary solvent system of solvent A (MQ water 0.01% TFA (trifluoroacetic acid)) and solvent B (MeOH (methanol), 0.01% TFA) and monitored at 210 nm (Shimadzu SPD-20A UV/Vis detector). Gradient HPLC conditions of 25% B to 98% B were employed over 60 min at a flow rate of 9 mL/min. Sixty fractions were collected between 1-60 min. Any strongly absorbing material was later eluted with 100% B to clean the column and generate a “waste” fraction for each sample. All corresponding fractions from the 5 repeat injections were combined and evaporated to dryness using a speed vacuum concentrator (Savant SC250EXP, Thermo Scientific).

Insecticidal activity was identified across fractions 40, 42, 44, 53, 55 and the column wash fraction HPLC fractions 42 (m/z 323) and 44 (m/z 337) contained the major metabolites in the extract and subsequent lyophilisation yielded the known podopyrones: 10′-oxopodopyrone (1c) and 10′-oxo-8-methyl podopyrone (11).

Fraction #42, colourless oil, 30.4 mg, ≥90% purity by NMR, 1.22% yield dry wt. of crude extract, not optimised; ¹H NMR (400 MHz, CDCl₃): 3.94 (³H, s, 2-OMe), 2.57 (2H, t, J=7.5 Hz H-1′), 2.39 (2H, t, J=7.1 Hz H-9′), 2.11 (3H, s, 11′-Me), 1.91 (3H, S, H-7), 1.83 (3H, s, H-8), 1.62 (2H, dt, J=7.4, 6.9 Hz H-2′), 1.54 (2H, m, H-8′), 1.4-1.2 (10H, m, H-3′-H7′). Lit. ¹H NMR 400 MHz, CDCl₃^{, 13}C NMR 67.9 MHz CDCl₃ (Jaensch et al., Pyrones and other constituents from Podolepis species, Phytochemistry, 28, 3497-3501, 1989; (+)-LRAPCIMS m/z (rel. int.): [M+H⁺] (100%), calcd for C₁₉H₃₁O₄, 323.222 (100).

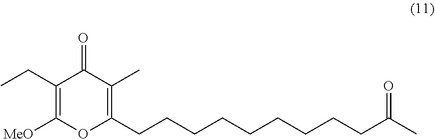 [SMILES: CCc1c(OC)oc(CCCCCCCCCC(C)=O)c(C)c1=O]

Fraction 44, colourless oil, 38.2 mg, ≥95% purity by NMR, 1.53% yield dry wt. of the crude extract, not optimised; ¹H NMR (400 MHz, CD₃OD): 4.03 (3H, s, 2-OMe), 2.69 (2H, t, J=7.4 Hz H-1′), 2.46 (2H, t, J=7.1 Hz H-9′), 2.38 (2H, q, J=7.5, 7.4 Hz H-8), 2.12 (3H, s, 11′-Me), 1.92 (3H, S, H-7), 1.70 (2H, dt, J=7.2, 7.4 Hz H-2′), 1.55 (2H, m, H-8′), 1.3-1.5 (10H, m, H-3′-H7′), 1.00 (3H, t, J=7.4 Hz, H-9). Lit. ¹H NMR 400 MHz, CDCl₃ (Zdero et al., Pyrone derivatives from Podolepis hieracioides and sesquiterpene acids from Cassinia longifolia, Phytochemistry, 26, 187-190, 1986; (+)-LRAPCIMS m/z (rel. int.): [M+H⁺] calcd for C₂₀H₃₃O₄, 337.238, 337 (100).

Samples of these podopyrones (1c) and (1l) as well as three fractions of #68N were provided for bioassay against cotton aphid. The bioassays were conducted as previously described.

The results (Table 10) show that podopyrones are the active metabolites in P. jaceoides methanol extract and N fraction. Mortality increased as podopyrone concentration increased, with 100% mortality at 0.0625% w/v. Also, the most active fraction was at 19-30 min, followed by 14-19 min. These two fractions contain podopyrones.

TABLE 10
Activity of podopyrones (combined fractions #42 and #44) and
P. jaceoides extract fractions against cotton aphid at 24 and 48 HAT

| | | Corrected % | Corrected % |
|---|---|---|---|
| | | mortality | mortality |
| Treatment | N | 24 HAT | 48 HAT |
| Control | 38 | | |
| Podopyrones 0.00625% | 32 | 32.14 | 40.78 |
| Podopyrones 0.0125% | 45 | 58.98 | 85.84 |
| Podopyrones 0.025% | 49 | 64.55 | 85.10 |
| Podopyrones 0.0625% | 44 | 100.00 | 100.00 |
| Podopyrones 1.00% | 38 | 100.00 | 100.00 |
| P. jaceoides HPLC fraction 0-14 | 36 | 9.52 | 12.54 |
| min | | | |
| P. jaceoides HPLC fraction 14-19 | 39 | 49.89 | 52.67 |
| min | | | |
| P. jaceoides HPLC fraction | 48 | 100.00 | 100.00 |
| 19-30 min | | | |

### Example 11: Mode of Action—Ion Flux Response

An electrophysiology technique was used known as micro-electrode Ion Flux Estimation (MIFE) to measure the net ion flux of the cell communities (using Schneider's Drosophila cell line, D.mel-S2). Cells were measured under control conditions for 15 minutes, followed by each treatment for a further 25-35 minutes. Chambers were used to hold very small quantities of γ-pyrones for treatments, with known quantities of cells deposited on glass stages for measuring of equal population size in each recording.

Ion selective microelectrodes were placed in close proximity (40 μm at position 1—a first position) to the surface of the cell population and moved slowly away from the surface (80 μm at position 2—a second position) by a computer driven micromanipulator, without disturbing the surrounding solution. The change (A) in ion concentration between the two positions is used to calculate the net ion influx or efflux by the cells, giving an indication of which ion challenges were actively pumping, co-transporting or allowing passive diffusion after treatment.

The results showed that γ-pyrones elicited nerve poisoning-type modes of action.

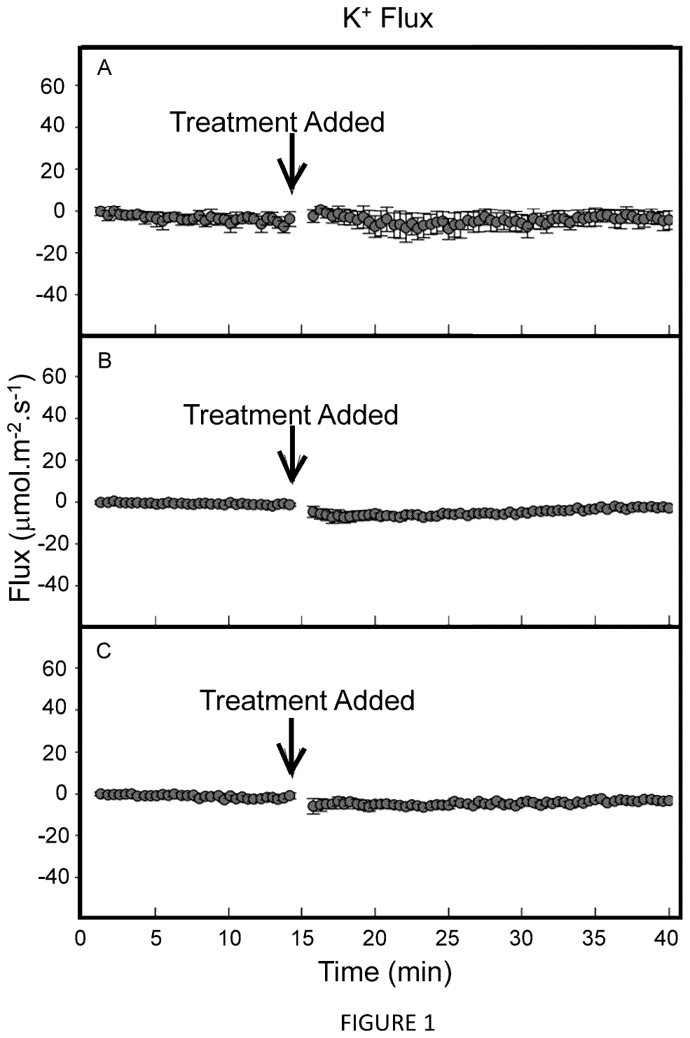

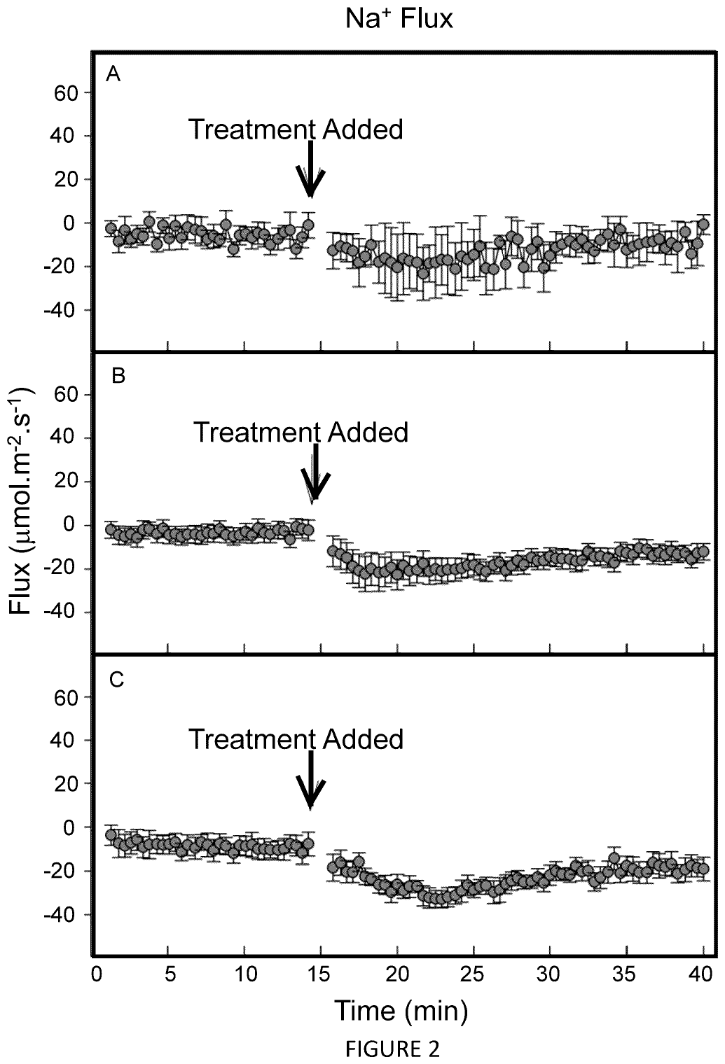

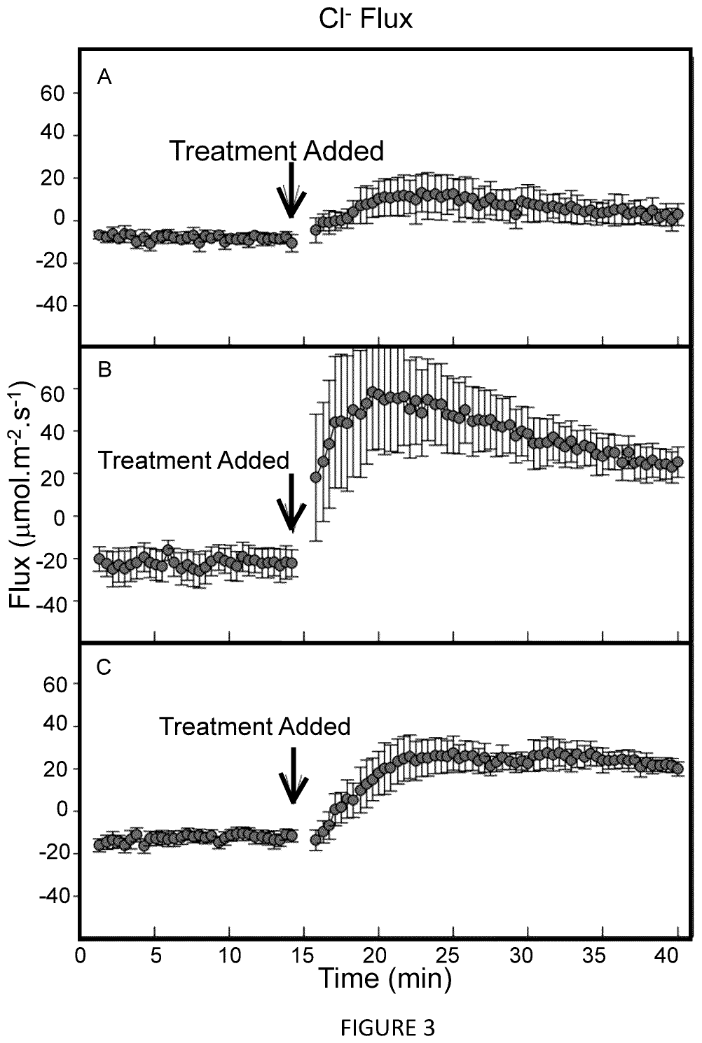

FIGS. 1-3 shows MIFE traces of net potassium, sodium and chloride flux as a comparative example. A) shows the influence of the negative control DMSO at 1.0%, B) shows the positive control pyrethrum at 0.01% and C) shows the plant extract positive control Tasmanone at 0.01%.

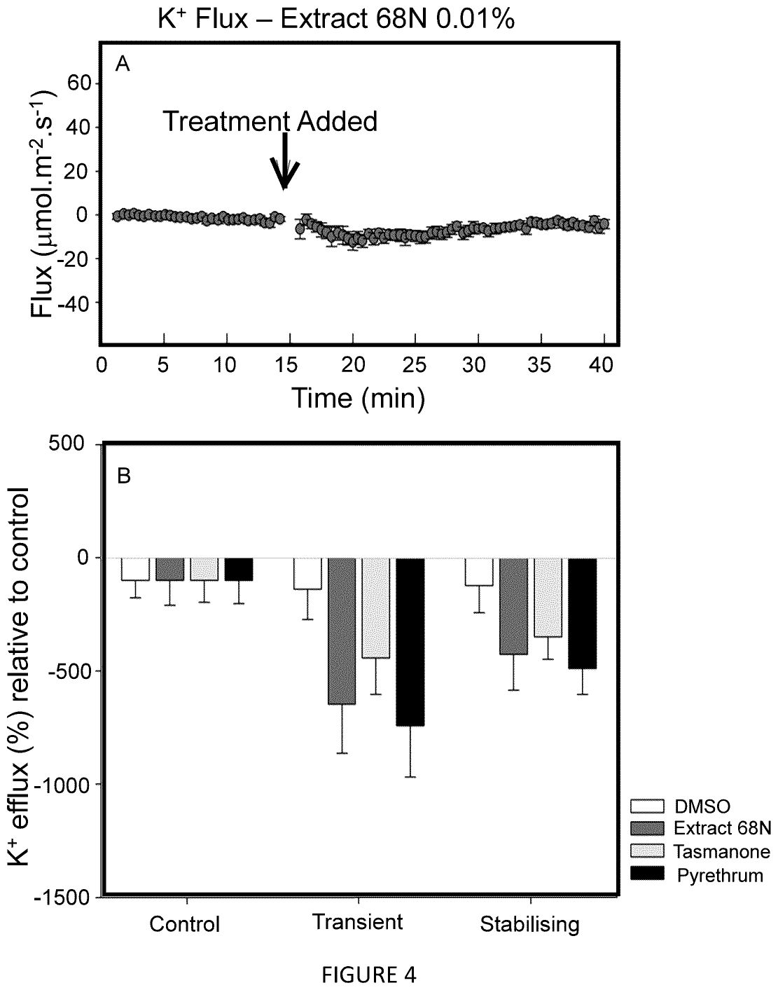

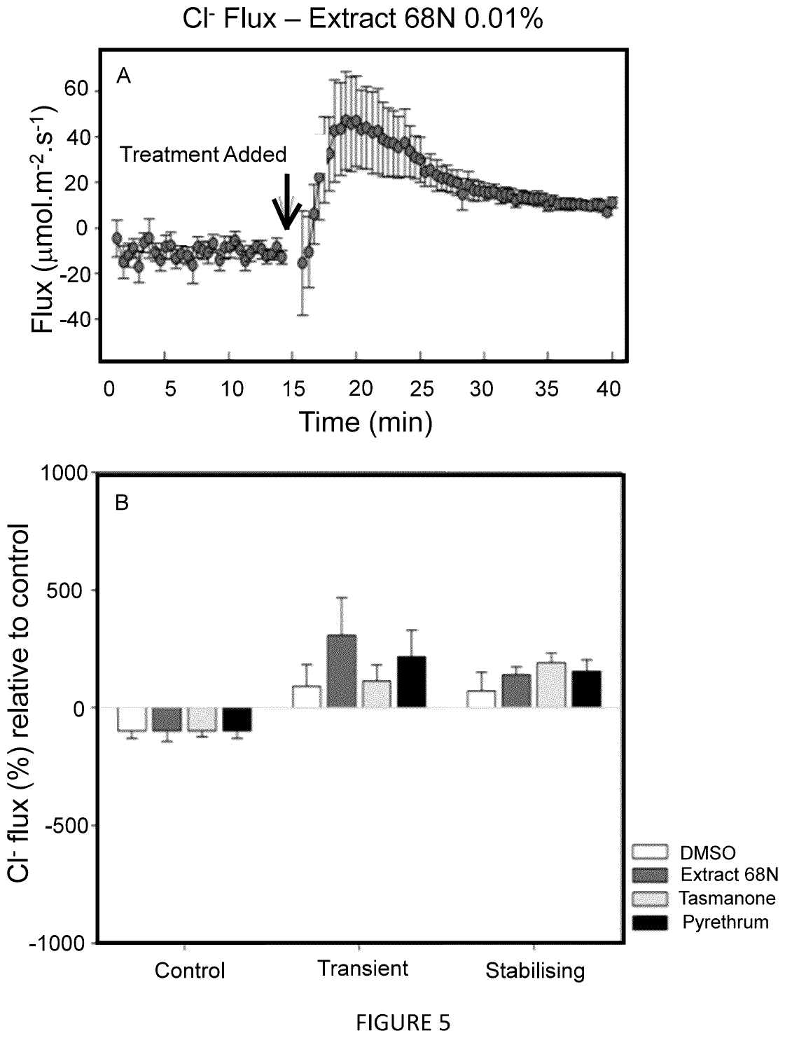

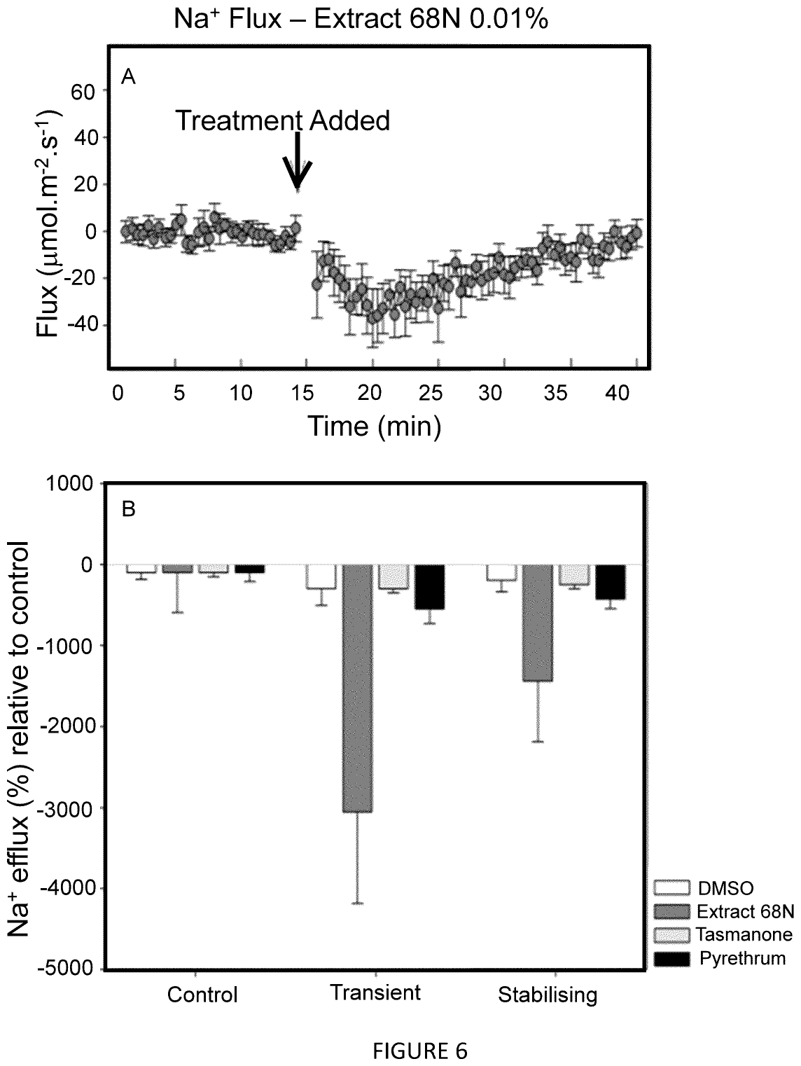

FIGS. 4-6 shows net ion flux as measured for the extracts of the present invention and compared against the positive controls for comparison.

Using D.mel-S2 cells, γ-pyrone containing non-polar extract as used in Examples 1-9, demonstrated multiple nerve cell activity, causing an efflux of both potassium and sodium ions and an influx in chloride ions.

The γ-pyrone containing non-polar extract elicited significant K⁺efflux concentrations and Cl⁻influx concentrations similar to pyrethrum, whilst also causing significant Na⁺efflux concentrations that outperform pyrethrum in both magnitude and persistence having a dual mode of action (FIGS. 4-6).

The ability of this extract to elicit multiple ion flux responses is surprising, as it suggests multiple modes-of-action. This, coupled with the persistently high Na⁺efflux in the stabilising phase of measurements, demonstrates that this extract may not be easily metabolised by the cells for detoxification.

Those skilled in the art will appreciate that the invention described herein is susceptible to variations and modifications other than those specifically described. It is understood that the invention includes all such variations and modifications which fall within the spirit and scope of the present invention.

1. A γ-pyrone compound for use as an insecticide.

2. A compound according to claim 1, wherein the γ-pyrone is of the general Formula (1): 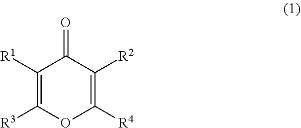
wherein:
R¹, R², R³ and R⁴ are each independently selected from an optionally substituted C₁-C₁₂ alkyl, preferably C₁-C₆ alkyl, more preferably C₁-C₂ alkyl; H; —COOH; —OH; —OCH₃ or —R⁵(CH2)ₙR⁶R⁷CH_{3;}
R⁵, R⁶, and R⁷ are each independently selected from an optionally substituted C₁-C₁₂ alkyl, preferably C₁-C₆ alkyl, more preferably C₁-C₂ alkyl; —C═O; —COO—, N, S or O; and
n is 1 to 18,
a salt, solvate, dimer or isomer thereof.

3. A compound according to claim 1, wherein the γ-pyrone is of the general Formula (1): 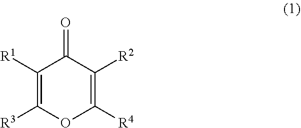
wherein:
R¹, R², R³ and R⁴ are each independently selected from C₁-C₁₂ alkyl, preferably C₁-C₆ alkyl, more preferably C₁-C₂ alkyl, wherein said C₁-C₁₂ alkyl, C₁-C₆ alkyl and C₁-C₂ alkyl may be optionally substituted with an epoxide, glycoside, acetoxy, halogen, cyano, amino, alcohol, phenyl, heteroaryl; H; —COOH; —OH; —OCH₃ or —R⁵(CH2)ₙR⁶R⁷CH_{3;}
R⁵, R⁶, and R⁷ are each independently selected from C₁-C₁₂ alkyl, preferably C₁-C₆ alkyl, more preferably C₁-C₂ alkyl, wherein said C₁-C₁₂ alkyl, C₁-C₆ alkyl and C₁-C₂ alkyl may be optionally substituted with an C₁-C₁₂ alkyl, preferably C₁-C₆ alkyl, more preferably C₁-C₂ alkyl, epoxide, glycoside, acetoxy, halogen, cyano, amino, alcohol, phenyl, heteroaryl; —CO═O; —COO—, N, S or O; and
n is 1 to 18,
a salt, solvate, dimer or isomer thereof.

4. A compound according to claim 1, wherein the γ-pyrone is of the general Formula (1): 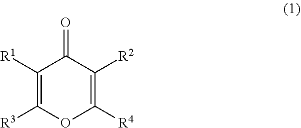
wherein:
R¹, R², R³ and R⁴ are each independently selected from C₁-C₁₂ alkyl, preferably C₁-C₆ alkyl, more preferably C₁-C₂ alkyl; H; —COOH; —OH; —OCH₃; or —R⁵(CH2)ₙR⁶R⁷CH_{3;}
R⁵, R⁶, and R⁷ are each independently selected from C₁-C₁₂ alkyl, preferably C₁-C₆ alkyl, more preferably C₁-C₂ alkyl, wherein said C₁-C₁₂ alkyl, C₁-C₆ alkyl and C₁-C₂ alkyl may be optionally substituted with an C₁-C₁₂ alkyl, preferably C₁-C₆ alkyl, more preferably C₁-C₂ alkyl, epoxide, glycoside, acetoxy, halogen, cyano, amino, alcohol, phenyl, heteroaryl; —CO═O; —COO—, N, S or O; and
n is 1 to 18,
a salt, solvate, dimer or isomer thereof.

5. A compound according to claim 1, wherein the γ-pyrone is of the general Formula (1): 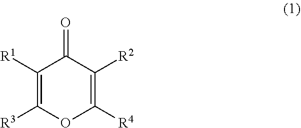
wherein:
R¹, R², R³ and R⁴ are each independently selected from C₁-C₁₂ alkyl, preferably C₁-C₆ alkyl, more preferably C₁-C₂ alkyl; H; —COOH; —OH; —OCH₃; or —R⁵(CH2)ₙR⁶R⁷CH_{3;}
R⁵, R⁶, and R⁷ are each independently selected from C₁-C₁₂ alkyl, preferably C₁-C₆ alkyl, more preferably C₁-C₂ alkyl, wherein said C₁-C₁₂ alkyl, C₁-C₆ alkyl and C₁-C₂ alkyl may be optionally substituted with an C₁-C₁₂ alkyl, preferably C₁-C₆ alkyl, more preferably C₁-C₂ alkyl, epoxide, glycoside, acetoxy, halogen, cyano, amino, alcohol, phenyl, heteroaryl; —CO═O; —COO—, N, S or O; and
n is 1 to 18,
with the proviso that at least one of R¹, R², R³ and R⁴ is R⁵(CH2)ₙR⁶R⁷CH_{3,}
a salt, solvate, dimer or isomer thereof.

6. A compound according to claim 1, wherein the γ-pyrone is of the general Formula (2): 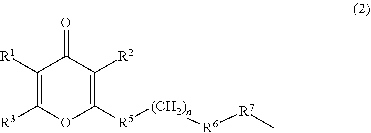
wherein:
R¹, R², R³ are each independently selected from C₁-C₁₂ alkyl, preferably C₁-C₆ alkyl, more preferably C₁-C₂ alkyl, wherein said C₁-C₁₂ alkyl, C₁-C₆ alkyl and C₁-C₂ alkyl may be optionally substituted with an epoxide, glycoside, acetoxy, halogen, cyano, amino, phenyl, heteroaryl; H; —COOH; —OH; or —OCH_{3,}
R⁵, R⁶, and R⁷ are each independently selected from C₁-C₁₂ alkyl, preferably C₁-C₆ alkyl, more preferably C₁-C₂ alkyl, wherein said C₁-C₁₂ alkyl, C₁-C₆ alkyl and C₁-C₂ alkyl may be optionally substituted with an C₁-C₁₂ alkyl, preferably C₁-C₆ alkyl, more preferably C₁-C₂ alkyl, epoxide, glycoside, acetoxy, halogen, cyano, amino, alcohol, phenyl, heteroaryl; —CO═O; —COO—, N, S or O; and
n is 1 to 18,
a salt, solvate, dimer or isomer thereof.

7. A compound according to claim 1, wherein the γ-pyrone is of the general Formula (2): 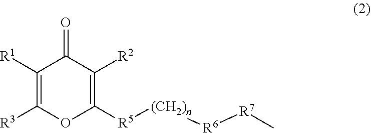
wherein:
R¹, R², R³ are each independently selected from C₁-C₁₂ alkyl, preferably C₁-C₆ alkyl, more preferably C₁-C₂ alkyl; H; —COOH; —OH; or —OCH_{3;}
R⁵, R⁶, and R⁷ are each independently selected from C₁-C₁₂ alkyl, preferably C₁-C₆ alkyl, more preferably C₁-C₂ alkyl, wherein said C₁-C₁₂ alkyl, C₁-C₆ alkyl and C₁-C₂ alkyl may be optionally substituted with an C₁-C₁₂ alkyl, preferably C₁-C₆ alkyl, more preferably C₁-C₂ alkyl, epoxide, glycoside, acetoxy, halogen, cyano, amino, alcohol, phenyl, heteroaryl; —CO═O; —COO—, N, S or O; and
n is 1 to 18,
a salt, solvate or isomer thereof.

8. A compound according to claim 1, wherein the γ-pyrone is of the general Formula (3): 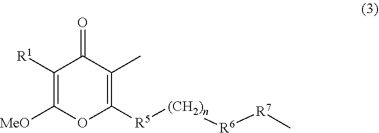
wherein:
n is 6, 7 or 8;
R¹ is C₁-C₁₂ alkyl, preferably C₁-C₆ alkyl, more preferably C₁-C₂ alkyl; and
R⁵, R⁶ and R⁷ are each independently selected from —CO═O and —CH₂—, with the proviso that if one of R⁵, R⁶ and R⁷ is —CO═O then the remaining groups are —CH₂—.

9. A compound according to claim 1, wherein the γ-pyrone is selected from the group consisting of compounds (1a) to (1q): 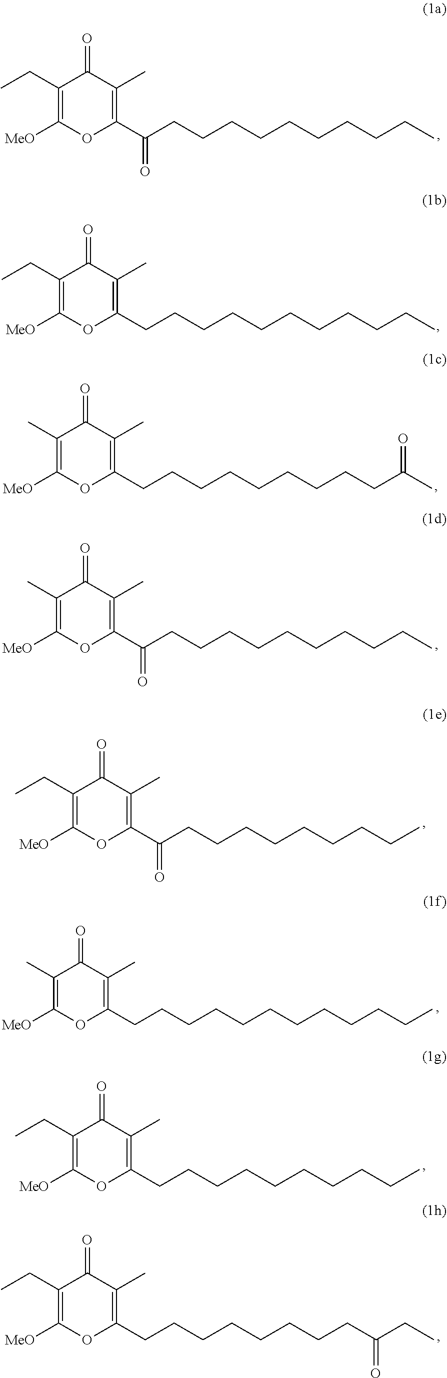 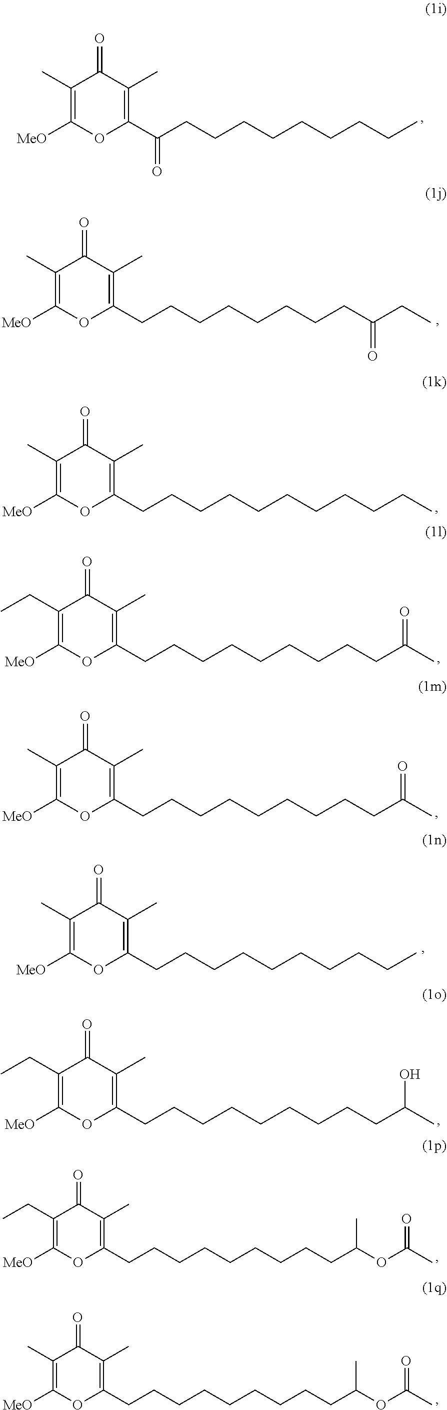
a salt, solvate, dimer or isomer thereof.

10. An insecticidal composition comprising a compound as defined according to claim 1.

11-13. (canceled).

14. An insecticidal composition according to claim 10, wherein the insect pests are selected from cotton bollworm, native budworm, green mirids, aphids, green vegetable bugs, apple dimpling bugs, thrips (plaque thrips, tobacco thrips, onion thrips, western flower thrips), white flies, two spotted mites, fleas, lice, mosquitoes, flies, tsetse flies, ants, ticks, mites, silverfish, chiggers and the like.

15. (canceled).

16. A formulation for controlling insect pests, said formulation comprising:
one or more agronomically-acceptable diluents and/or carriers and/or other additives such as emulsifiers, wetting agents, surfactants, stabilisers, spreaders or the like; and
an insecticidally-effective amount of an insecticidal compound according to claim 1 or an insecticidal composition according to claim 10,
wherein the formulation, in use, elicits insecticidal activity and/or repels the insect pest and/or deters the insect pest from laying eggs and/or influences the position of egg laying and/or deters the insect pest from feeding on a plant.

17. Use of an insecticidally-effective amount of a compound according to claim 1 or an insecticidal composition according to claim 10 for controlling insect pests by eliciting insecticidal activity and/or repelling the insect pest and/or deterring the insect pest from laying eggs and/or influencing the position of egg laying and/or deterring the insect pest from feeding on a plant.

18. A method of controlling one or more insect pests, the method comprising treating a locus with an insecticidally-effective amount of a compound according to claim 1 or an insecticidal composition according to claim 10, by eliciting insecticidal activity and/or repelling the insect pest and/or deterring the insect pest from laying eggs and/or influencing the position of egg laying and/or deterring the insect pest from feeding on a plant.

19. A method according to claim 18, wherein the compound according to claim 1 or an insecticidal composition according to claim 10 affects at least two ion channels of the insect pest.

20. A method according to claim 19, wherein the compound according to claim 1 or an insecticidal composition according to claim 10 affects at least two neuronal ion channels of the insect pest.

21. A method according to claim 18, wherein the at least two ion channels are selected from the group consisting of sodium, potassium and chloride ion channels.

22. A method according to claim 21, wherein the compound according to claim 1 or an insecticidal composition according to claim 10 causes an efflux of sodium and potassium ions.

23. A method according to claim 22, wherein the compound according to claim 1 or an insecticidal composition according to claim 10 causes an influx of chloride ions.

24. A kit for on-the-shelf sale, the kit comprising:
a compound according to claim 1 or an insecticidal composition according to claim 10;
one or more agronomically-acceptable diluents and/or carriers and/or other additives such as emulsifiers, wetting agents, surfactants, stabilisers, spreaders or the like;
instructions for preparing a formulation comprising an insecticidally-effective amount of the compound according to claim 1 or an insecticidal composition according to claim 10 per unit volume of the one or more agronomically-acceptable diluents and/or carriers and/or other additives such as emulsifiers, wetting agents, surfactants, stabilisers, spreaders or the like.
